(19) United States
(12) Patent Application Publication
(10) Pub. No.: US 2010/0083133 A1
(43) Pub. Date: Apr. 1, 2010

(54) E-MAIL DELIVERY METHOD, E-MAIL DELIVERY SYSTEM, AND SERVER USED THEREFOR

(76) Inventor: Hiromitsu TAKAYAMA, Tokyo (JP)

Correspondence Address: KRATZ, QUINTOS & HANSON, LLP, 1420 K Street, N.W., Suite 400, WASHINGTON, DC, 20005, US

(21) Appl. No.: 12/570,551

(22) Filed: Sep. 30, 2009

(30) Foreign Application Priority Data
Sep. 30, 2008 (JP) 2008-253476

(51) Int. Cl. G06F 15/16; G06F 3/01

(52) U.S. Cl. 715/752; 709/206

(57) ABSTRACT

An e-mail delivery system that makes it possible (1) for the end-user of the client terminal to set up a mailbox with a customized mail theme and to receive only those e-mails that comply with the pre-specified mail theme(s), (2) that enables the end-user to easily generate a new mail theme that is related to e-mail and mailbox, (3) that allows both the mail sender and the mailbox owner to actually edit the e-mail after it reaches the mailbox, and (4) that also allows the mailbox owner to receive advertising banners in which she/he has interest, using the mail theme.

### RELATED APPLICATION

This application is based on and claims priority of Japanese patent application No. 2008-253476 filed on Sep. 30, 2008.

### BACKGROUND OF THE INVENTION

The present invention relates to an e-mail (an electronic mail) delivery method, an e-mail delivery system, and a server used therefor.

### BACKGROUND ART

U.S. Patent application 2001/0007993 discloses a conventional mail delivery system. A mail sender using this delivery system writes an e-mail involving a receiver's mailbox address using a client terminal held by the mail sender. Then the e-mail is transmitted from the sender's client terminal to receiver's mailbox via a communication network such as the internet.

On the other hand, the user owns a mailbox for receiving the e-mails on which the user is designated as the receiver. He/she selects the e-mail among those received by using the mailbox, and browses it. Then, the receiver who browsed the e-mail creates a new mail as a return e-mail to the sender.

Therefore, in the usual mail delivery system, communication is built upon repetitive e-mail sending with a specified receiver's mailbox address. In other words, in the conventional method for delivering e-mails, the communication is based on e-mail communication only among the users who know the mutual mailbox address.

### SUMMARY OF THE INVENTION

In the usual e-mail delivery system, the e-mail sender writes an e-mail involving a mailbox address so that the e-mail will be delivered to a specific mailbox. However, in this kind of e-mail delivery system, the mail sender needs to know a specific e-mailbox address in order to send an e-mail.

If the e-mail sender intends to write an e-mail under a particular theme, and wants all mailbox owners interested in that theme to receive his/her e-mail, then the mail sender needs to collect all of those owner's mailbox addresses. It is therefore a prerequisite to know which people are interested in what theme and to collect their mail addresses accordingly.

Also, in the usual e-mail delivery system, sending an e-mail is a single event. When or if communication between the mail sender and the owner of the mailbox expands or builds up over time, several processes of e-mail exchange are required. This is inconvenient and generates verbosity. And communication history between the mail sender and the owner of the mailbox is not maintained, which makes the past messages difficult to consult.

Today, while reengineering of network communications is taking place, an e-mail delivery system suitable for the new age is anticipated. The e-mail delivery system normally used is an analogy to the physical surface mail delivery system. Therefore, a new concept is required, for an e-mail delivery system which can improve the convenience for user.

The present invention has been made in consideration of the above situation, and has as its object to provide an e-mail delivery method and an e-mail delivery system which can improve the convenience for a user.

According to the first aspect, the present invention is an e-mail delivery method used in an e-mail delivery system in which a plurality of client terminals is connected to an e-mail delivery server via a network, comprising the steps of: transmitting a first request for first information from a client terminal in the plurality of client terminals to the e-mail delivery server, the first information being an overview information of e-mails related to a mail-box provided for the client terminal in the e-mail delivery server, the e-mails being transmitted from the plurality of client terminals with a mail sender and a mail title; transmitting the first information from the e-mail delivery server to the client terminal; displaying the overview of the e-mails on a screen of the client terminal, based on the first information received from the e-mail delivery server; transmitting a second request for second information from the client terminal to the e-mail delivery server; the second information being e-mail information of an e-mail chosen among the overview of the e-mails displayed; transmitting the second information from the e-mail delivery server to the client terminal; and displaying the e-mail on the screen of the client terminal, based on the second information received from the e-mail delivery server.

By using this e-mail delivery method, the user of a client terminal is able to browse the overview of e-mails related to the mailbox provided for the client terminal and access every e-mail among the e-mails.

The e-mail delivery method of the present invention may further comprise the steps of: transmitting third information from the client terminal to the e-mail delivery server, the third information being that as an edited result by using the e-mail, referring the e-mail displayed; and updating e-mail information in the mailbox based on the third information received from the client terminal, when the client terminal is held by a sender of the e-mail and/or an owner of the mailbox. In this case, the user of the client terminal is able to update the email information in the mailbox.

Also, the e-mail delivery method of the present invention may further comprise the steps of: transmitting fourth information for generating a theme-designating mailbox from the client terminal to the e-mail delivery server, the theme-designating mailbox having a name, an owner's name, and a mail theme; generating the theme-designating mailbox in the e-mail delivery server, mails with the mail theme being related to the theme-designating mailbox. In this case, the user of the client terminal can own the theme-designating mailbox in addition to a normal mailbox, which is accessible from any client terminal.

In the case that the theme-designating mailbox is generated, the e-mail delivery method may further comprise the steps of: transmitting a third request for fifth information from the client terminal to the e-mail delivery server, the fifth information being used for selecting the mail theme; transmitting the fifth information from the e-mail delivery server to the client terminal; and displaying mail theme selecting information on the screen of the client terminal, based on the fifth information received from the e-mail delivery server. In this case, the user of the client terminal is able to select a mail theme easily.

In the case that the theme-designating mailbox is generated, the e-mail delivery method may further comprise the steps of: transmitting a fourth request for sixth information from the client terminal to the e-mail delivery server, the sixth information being overview information of mailboxes owned by the holder of the client terminal; transmitting the sixth information from the e-mail delivery server to the client terminal; and displaying the overview of the mailboxes on the screen of the client terminal, based on the sixth information received from the e-mail delivery server. In this case, the user of the client terminal is able to browse the overview of the mailboxes.

In the case that the theme-designating mailbox is generated, the e-mail delivery method may further comprise the steps of: transmitting a fifth request for seventh information from the client terminal to the e-mail delivery server, the seventh information being banner information corresponding to the mail theme of the theme-designating mailbox; transmitting the seventh information from the e-mail delivery server to the client terminal; and displaying the banner on the screen of the client terminal, based on the seventh information received from the e-mail delivery server. In this case, the user of the client terminal is able to browse the banner corresponding to the mail theme of the theme-designating mailbox.

In the case that the theme-designating mailbox is generated, the e-mail delivery method may further comprise the steps of: transmitting eighth information for registering a mail theme designated at the client terminal from the client terminal to the e-mail delivery server, the eighth information including the designated mail theme and at least one of parent themes, the at least one of parent themes belonging to a higher layer than a layer in which the designated mail theme is; and registering the designated mail theme into the e-mail delivery system. In this case, the user of the client terminal is able to register the designated mail theme with at least one of parent themes into the e-mail delivery system.

The eighth information may further include at least one of child themes of the designated mail theme, the at least one of the child themes being in a lower layer than the layer in which the designated mail theme is. In this case, the user of the client terminal is able to register the designated mail theme with at least one child theme into the e-mail delivery system.

According to the second aspect, the present invention is an e-mail delivery system in which a plurality of client terminals is connected to an e-mail delivery server via network, wherein a client terminal in the plurality of client terminals comprises: a display section configured to display various images; a first request section part configured to transmit a first request for first information in the plurality of client terminals to the e-mail delivery server, the first information being overview information of e-mails related to a mail-box in the e-mail delivery server, the e-mails being transmitted from the plurality of client terminals with a mail sender and a mail title; a first display control section configured to control the display section for displaying the overview of the e-mails on a screen of the display section, based on the first information received from the e-mail delivery server; a second request section configured to transmit a second request for second information to the e-mail delivery server; the second information being e-mail information of an e-mail chosen from the overview of the e-mails displayed; and a second display control section configured to control the display section for displaying the e-mail on the screen, based on the second information received from the e-mail delivery server; and wherein the e-mail delivery server comprises: a mail storage section configured to hold the e-mails; a mailbox storage section configured to hold mailbox information; a first response returning section configured to transmit the first information to the client terminal; and a second response returning section configured to transmit the second information to the client terminal.

In this e-mail delivery system, the e-mail delivery method of the present invention is performed. Therefore, by using this e-mail delivery system, the user of the client terminal is able to browse the overview of e-mails related to the mailbox provided for the client terminal and every e-mail among the e-mails.

In the e-mail delivery system of the present invention, the client terminal may further comprise an edited result transmitting section configured to transmit third information to the e-mail delivery server, the third information being that as an edited result by using the e-mail, referring the e-mail displayed, and the e-mail delivery server may further comprise an update section configured to update e-mail information in the mailbox based on the third information received from the client terminal, when the client terminal is held by a sender of the e-mail and/or an owner of the mailbox. In this case, the user of the client terminal is able to update the e-mail information in the mailbox.

Also, in the e-mail delivery system of the present invention, the client terminal may further comprise a mailbox information transmitting section configured to transmit fourth information for generating a theme-designating mailbox to the e-mail delivery server, the theme-designating mailbox having a name, an owner's name, and a mail theme, wherein the e-mail delivery server may further comprise a mailbox generating section configured to generate the theme-designating mailbox in the e-mail delivery server, mails with the mail theme being related to the theme-designating mailbox. In this case, the user of the client terminal can own the theme-designating mailbox in addition to a normal mailbox, which is accessible from any client terminal.

In the case that the theme-designating mailbox is generated, the client terminal may further comprise: a third request section configured to transmit third request for fifth information to the e-mail delivery server, the fifth information being used for selecting the mail theme; and a third display control section configured to control the display section for displaying a mail theme selecting user-interface image on the screen, based on the fifth information received from the e-mail delivery server; and the e-mail delivery server may further comprise a third response returning section configured to transmit the fifth information to the client terminal. In this case, the user of the client terminal is able to select a mail theme easily.

In the case that the theme-designating mailbox is generated, the client terminal may further comprise: a fourth request section configured to transmit a fourth request for sixth information to the e-mail delivery server, the sixth information being an overview information of mailboxes owned by holder of the client terminal; and a fourth display control section configured to control the display section for displaying the overview of the mailboxes at the client terminal, based on the sixth information received from the e-mail delivery server on the screen. The e-mail delivery server may further comprise a fourth response returning section configured to transmit the sixth information to the client terminal. In this case, the user of the client terminal is able to browse the overview of the mailboxes.

In the case that the theme-designating mailbox is generated, the client terminal may further comprise: a fifth request section configured to transmit a fifth request for seventh information to the e-mail delivery server, the seventh information being banner information corresponding to the mail theme of the theme-designating mailbox; and a fifth display control section configured to control the display section for displaying the banner on the screen, based on the seventh information received from the e-mail delivery server. The e-mail delivery server may further comprise a fifth response returning section configured to transmit the seventh information to the client terminal. In this case, the user of the client terminal is able to browse the banner corresponding to the mail theme of the theme-designating mailbox.

According to the third aspect, the present invention is an e-mail delivery server connected to a plurality of client terminals via a network, comprising: a mail storage section configured to hold the e-mails; a mailbox storage section configured to hold mailbox information; a first response returning section configured to transmit first information to the client terminal terminals in response to a first request received from the client terminal, the first information being an overview information of e-mails related to the mailbox, the e-mails being transmitted from the plurality of client terminals with a mail sender and a mail title; and a second response returning section configured to transmit second information to the client terminal in response to a second request received from the client terminal, the second information being e-mail information of an e-mail selected from the e-mails based on displayed result of the overview of the e-mails.

By using this e-mail delivery server, the mail delivery system according to the present invention can be structured easily.

The e-mail delivery server of the present invention may further comprise: an update section configured to update information of the e-mail in the mailbox based on third information received from the client terminal, the third information being an edited result of the e-mail performed by using a displayed result of the e-mail, wherein the client terminal is held by a sender of the e-mail and/or an owner of the mailbox.

The e-mail delivery server of the present invention may further comprise: a mailbox generating section configured to generate a theme-designating mailbox in the mailbox storage section when fourth information for generating the theme-designating mailbox is received from the client terminal, the theme-designating mailbox having a name, an owner's name, and a mail theme, mails with the mail theme being related to theme-designating mailbox.

In the case that the theme-designating mailbox is generated, the e-mail delivery server of the present invention may further comprise: a third response returning section configured to transmit fifth information to the client terminal in response to a third request received from the client terminal, the fifth information being used for selecting the mail theme in the client terminal.

In the case that the theme-designating mailbox is generated, the e-mail delivery server of the present invention may further comprise: a fourth response returning section configured to transmit sixth information to the client terminal in response to a fourth request received from the client terminal, the sixth information being overview information of mailboxes owned by the user of the client terminal.

In the case that the theme-designating mailbox is generated, the e-mail delivery server of the present invention may further comprise: a fifth response returning section configured to transmit seventh information to the client terminal in response to a fifth request received from the client terminal, the seventh information being banner information corresponding to the mail theme of the theme-designating mailbox.

As described above, the mail delivery method and the mail delivery system according the present invention can make convenience for the users of client terminals increase. And the mail delivery server according the present invention can be employed when the mail delivery system according the present invention is structured.

### BRIEF DESCRIPTION FOR THE DRAWINGS

FIG. 1 is a block diagram showing the configuration of the e-mail delivery system according to embodiment of the present invention.

FIG. 2 is a block diagram showing the configuration of the e-mail delivery server shown in FIG. 1.

FIG. 3 is a block diagram showing the configuration of the end-user section shown in FIG. 2.

FIG. 4 is an explanatory diagram of the contents in the end-user information storage section shown in FIG. 3.

FIG. 5 is a block diagram showing the configuration of the mail theme section shown in FIG. 2.

FIG. 6 is the first example of the contents in the mail theme storage section shown in FIG. 5.

FIG. 7 is the second example of the contents in the mail theme storage section in FIG. 5.

FIG. 8 is the first example of the contents in the mail theme storage section shown in FIG. 5.

FIG. 9 is the second example of the contents in the mail theme storage section shown in FIG. 5.

FIG. 10 is a block diagram showing the configuration of the mail section shown in FIG. 2.

FIG. 11 is an explanatory diagram of the contents in the mail storage section shown in FIG. 10.

FIG. 12 is a block diagram showing the configuration of the banner section shown in FIG. 2.

FIG. 13 is the first explanatory diagram of the contents in the banner storage section shown in FIG. 12.

FIG. 14 is the second explanatory diagram of the contents in the banner storage section shown in FIG. 12.

FIG. 15 is a block diagram showing the configuration of the client terminal shown in FIG. 1.

FIG. 16 is a sequence diagram for explaining the end-user registration process.

FIG. 17 is a sequence diagram for explaining the login process.

FIG. 18 is the first example of a mailbox overview.

FIG. 19 is the second example of the mailbox overview.

FIG. 20 is a sequence diagram for explaining the mailbox theme set up.

FIG. 21 is the example of a mail box setup interface.

FIG. 22 is the example of a mail theme selection interface.

FIG. 23 is the example of another mail theme selection interface.

FIG. 24 is the example of the mailbox setup interface containing the selected mail theme.

FIG. 25 is the example of another style of the mail box overview.

FIG. 26 is the example of the mail theme setup interface.

FIG. 27 is the example of the mail theme setup interface after parent mail themes and children mail themes are selected.

FIG. 28 is a sequence diagram for explaining the mail theme set up.

FIG. 29 is the third example of the mail theme storage section in FIG. 5.

FIG. 30 is the fourth example of the mail theme storage section in FIG. 5.

FIG. 31 is a sequence diagram of the mailbox overview displaying process.

FIG. 32 is the first examples of the mailbox.

FIG. 33 is the second examples of the mailbox.

FIG. 34 is the example of the mail having specific mail theme.

FIG. 35 is the first example of a mail write & send interface.

FIG. 36 is the second example of the mail write & send interface.

FIG. 37 is a sequence diagram of the e-mail creation process (steps P7-8 to P7-14).

FIG. 38 is the example of the e-mail having the specific mail theme.

FIG. 39 is the example of the mail write & send interface for the replay.

FIG. 40 is the third example of the mailbox overview.

FIG. 41 is the example of the mailbox.

FIG. 42 is the example of the mail having the specific e-mail theme from the end-user.

FIG. 43 is a sequence diagram of the e-mail editing process.

FIG. 44 is the first example of the e-mail to be edited.

FIG. 45 is the first example of the e-mail edit interface.

FIG. 46 is the first example of the updated e-mail.

FIG. 47 is the second example of an e-mail editing process.

FIG. 48 is the second example of the updated e-mail.

FIG. 49 is the third example of the e-mail edit interface.

FIG. 50 is the third example of the updated e-mail.

FIG. 51 is the fourth example of the updated e-mail.

FIG. 52 is the second example of the e-mail to be edited.

FIG. 53 is the fourth example of the e-mail edit interface.

FIG. 54 is the fifth example of the updated e-mail.

FIG. 55 is the fifth example of the e-mail edit interface.

FIG. 56 is the sixth example of the updated e-mail.

### DETAILED DESCRIPTION

In the following, embodiments of the present invention will be explained with reference to attached drawings.

### First Embodiment

Firstly, the first embodiment according to this invention will be explained.

<Configuration>

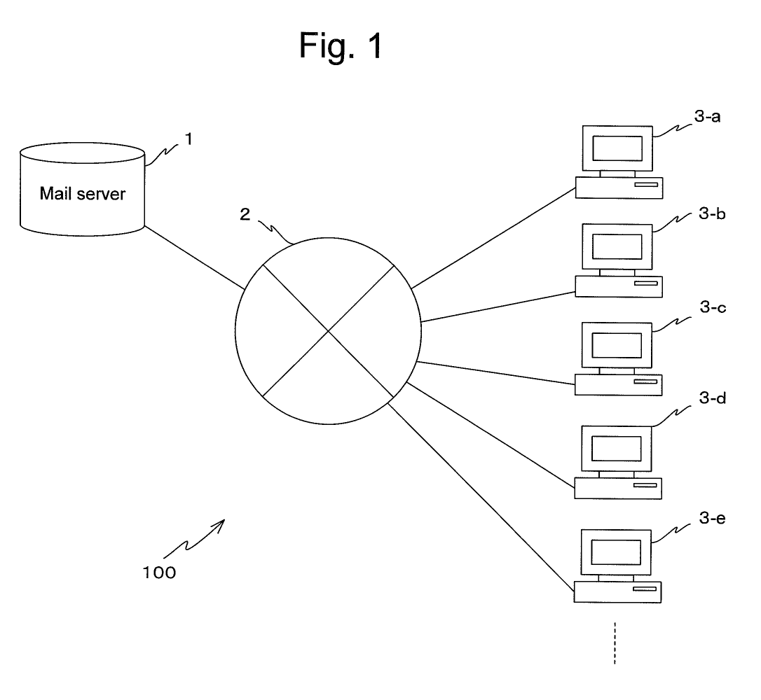

The schematic configuration of an e-mail delivery system 100 according to the first embodiment is shown in FIG. 1 as a block diagram. As shown in FIG. 1, this e-mail delivery system 100 comprises an e-mail delivery server 1 (“the mail server 1” hereinafter), a communication network 2 such as the internet (“the internet 2” herein after), and client terminals 3-a, 3-b, . . . .

The mail server 1 provides a varied service for delivering e-mails to the client terminals 3-a, 3-b, . . . . This mail server 1 comprises an end-user information section 1a, a mailbox section 1b, a mail section 1c, and a banner section 1d. The mail server 1 further comprises a transmitting/receiving section 6.

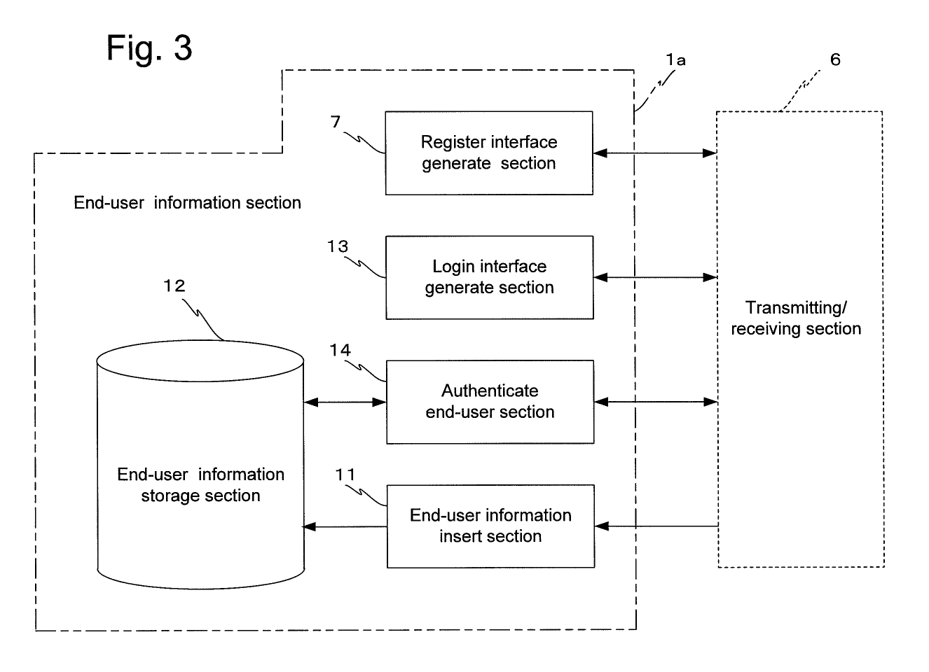

The end-user information section 1a manages end-user information. As shown FIG. 3, this end-user information section 1a comprises a register interface generate section 7, an end-user information insert section 11, and an end-user information storage section 12. The end-user information section 1a further comprises a login interface generate section 13 and an authenticate end-user section 14.

The register interface generate section 7 generates end-user registration interface information for display at the client terminal 3-x (x=a, b, . . . ) in response to a request of the end-user registration interface information from the client terminal 3-x through the transmitting/receiving section 6. Then the register interface generate section 7 transmits the generated end-user registration interface information to the client terminal 3-x through the transmitting/receiving section 6.

The end-user information insert section 11 receives new end-user information form the client terminal 3-x through the transmitting/receiving section 6. Then the end-user information insert section 11 stores the new end-user information into the end-user information storage section 12.

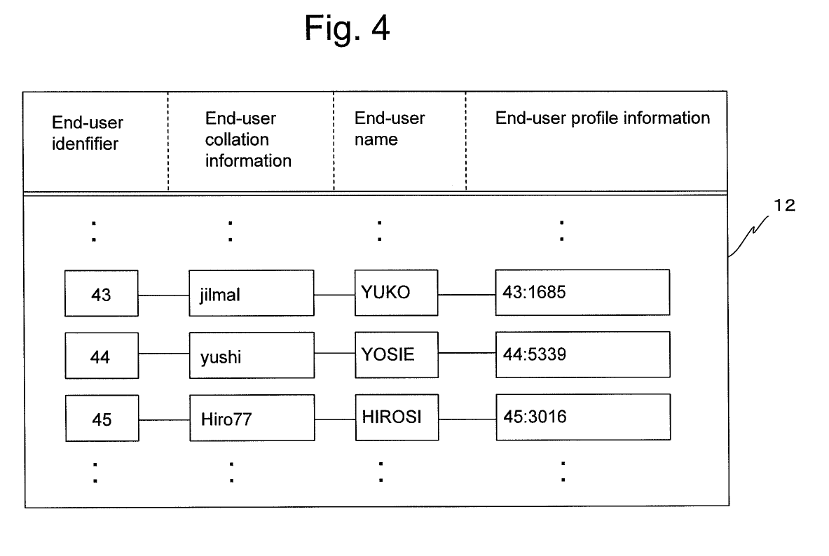

The end-user information storage section 12 holds the end-user information. The example of the end-user information is shown in FIG. 4. As shown in FIG. 4, in this embodiment, individual end-user information in the end-user information storage section 12 is composed of end-user identifier number, end-user collation information, end-user name, and end-user profile information.

Returning to FIG. 3, the login interface generate section 13 generates login interface information for displaying at the client terminal 3-x in response to a request of the login interface information from the client terminal 3-x through the transmitting/receiving section 6. Then, the login interface generate section 13 transmits the generated login interface information to the client terminal 3-x through the transmitting/receiving section 6.

The authenticate end-user section 14 receives login information including user name and password from the client terminal 3-x through the transmitting/receiving section 6. Subsequently, the authenticate end-user section 14 extracts the end-user name and password from the login information, and also extracts the password corresponding to the user name designated in the login information from the end-user information storage section 12. Then, the authenticate end-user section 14 authenticates the user of the client terminal 3-x, when the extracted password is the same as the password designated in the login information.

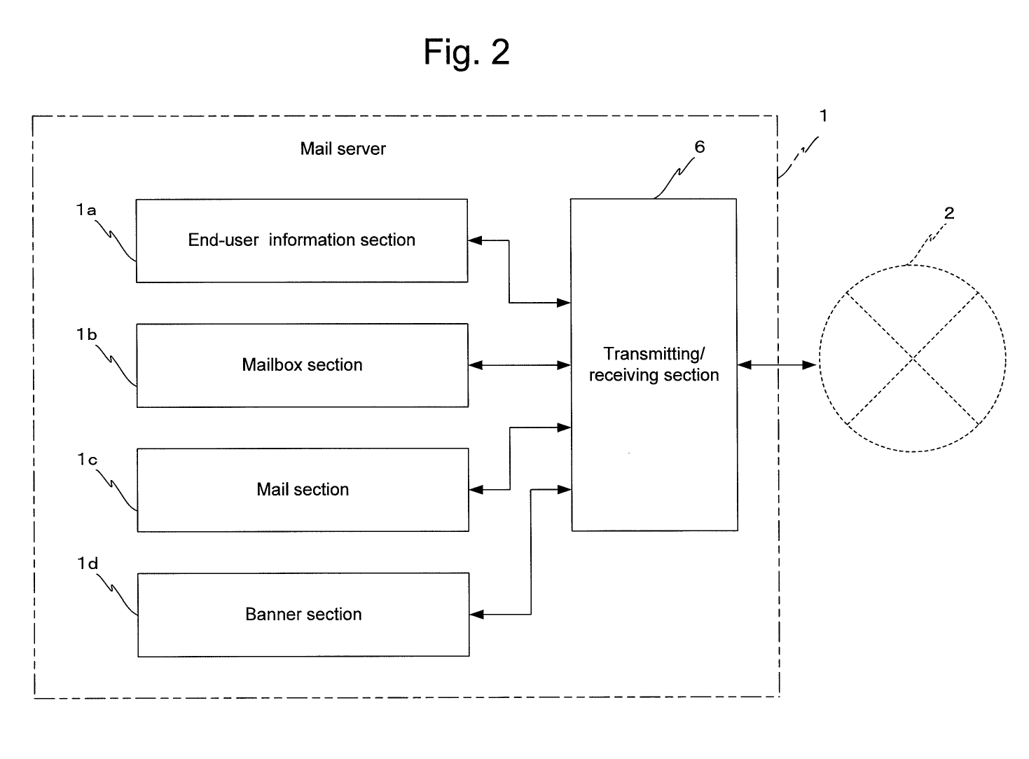

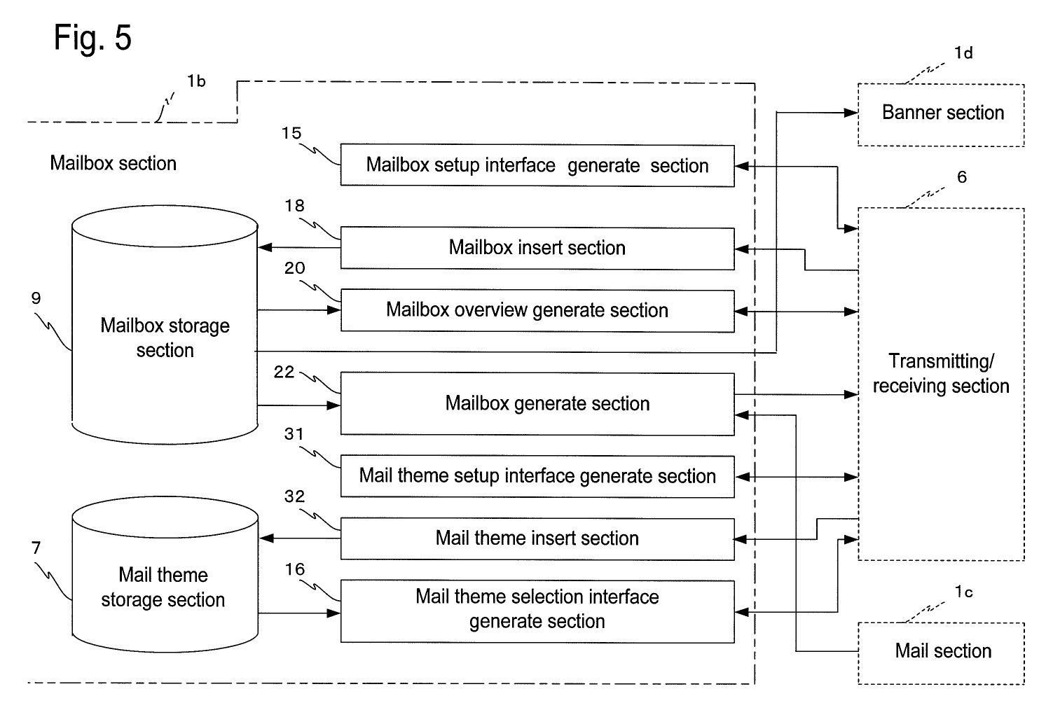

Returning to FIG. 2, the mailbox section 1b manages mailbox information and mail information. As shown in FIG. 5, this mailbox section comprises a mail theme setup interface generate section 31, a mail theme insert section 32, a mail theme selection interface generate section 16, and a mail theme storage section 17. The mailbox section further comprises a mailbox setup interface generate section 15, a mailbox insert section 18, a mailbox storage section 19, a mailbox overview generate section 20, and a mailbox generate section 22.

The mail theme setup interface generate section 31 generates mail theme setup interface information for displaying at the client terminal 3-x in response to a request of the mail theme setup interface information from the client terminal 3-x through the transmitting/receiving section 6. Then, the mail theme setup interface generate section 31 transmits the generated mail theme setup interface information to the client terminal 3-x through the transmitting/receiving section 6.

The mail theme insert section 32 receives new mail theme information from the client terminal 3-x through the transmitting/receiving section 6. Then, the mail theme insert section 32 inserts the new mail theme into the mail theme storage section 17.

The mail theme selection interface generate section 16 generates mail theme selection interface information for displaying at the client terminal 3-x in response to a request of the mail theme selection interface information from the client terminal 3-x through the transmitting/receiving section 6. Then, the mail theme selection interface generate section 16 transmits the generated mail theme selection interface information to the client terminal 3-x through the transmitting/receiving section 6.

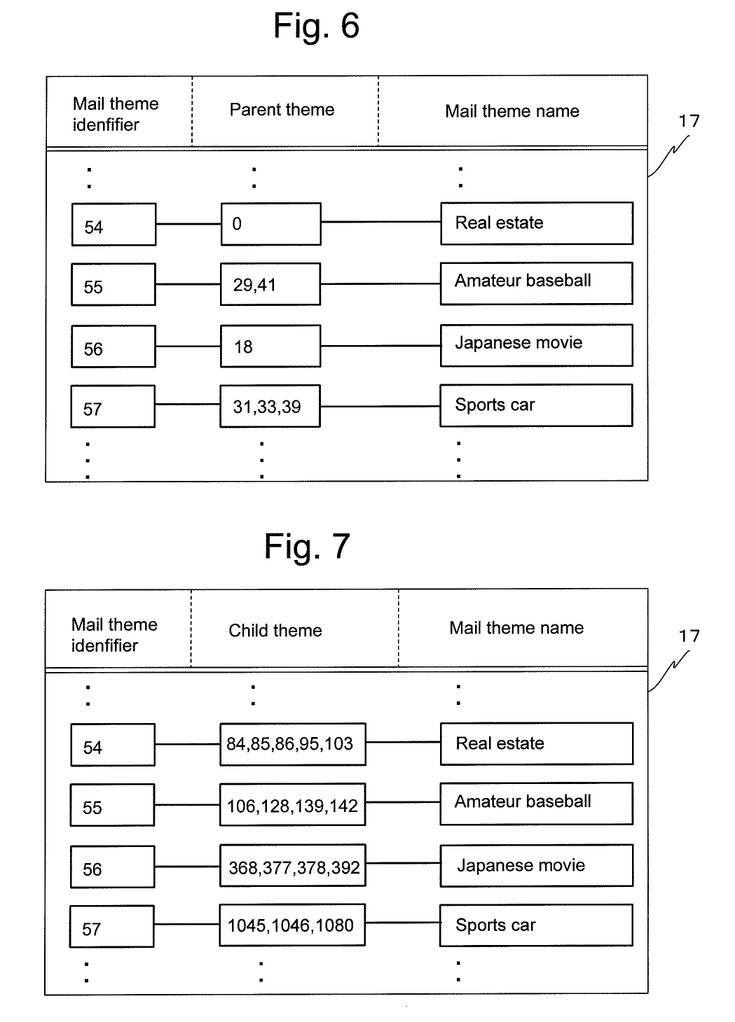

The mail theme storage section 17 holds mail theme information. The two examples of the mail theme information are shown in FIG. 6 and FIG. 7. The first example of the mail theme information is shown in FIG. 6. As shown in FIG. 6, in the first example, individual mail theme is composed of mail theme identifier, parent theme, and mail theme name. The second example of the mail theme information is shown in FIG. 7. As shown in FIG. 7, in the second example, the individual mail theme is composed of mail theme identifier, child theme, and mail theme name. Note that the individual mail theme can include the parent theme and/or the child theme.

Returning to FIG. 5, the mailbox setup interface generate section 15 generates mailbox setup interface information for displaying at the client terminal 3-x in response to a request of the mailbox setup interface information from the client terminal 3-x through the transmitting/receiving section 6. Then, the mailbox setup interface generate section 31 transmits the generated mailbox setup interface information to the client terminal 3-x through the transmitting/receiving section 6.

The mailbox insert section 18 receives new mailbox information from the client terminal 3-x through the transmitting/receiving section 6. Then, the mailbox insert section 32 inserts the new mailbox information into the mailbox storage section 19.

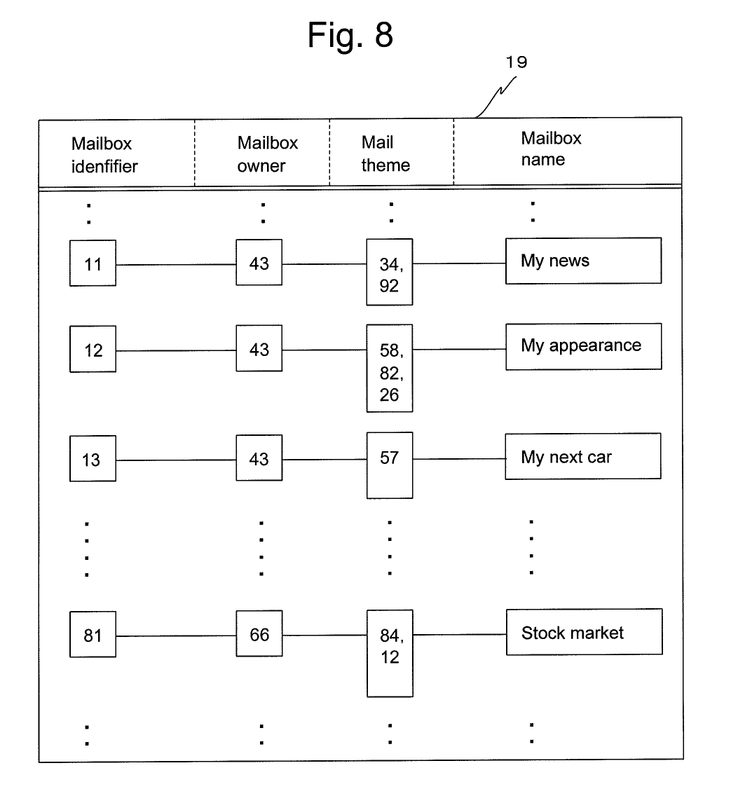

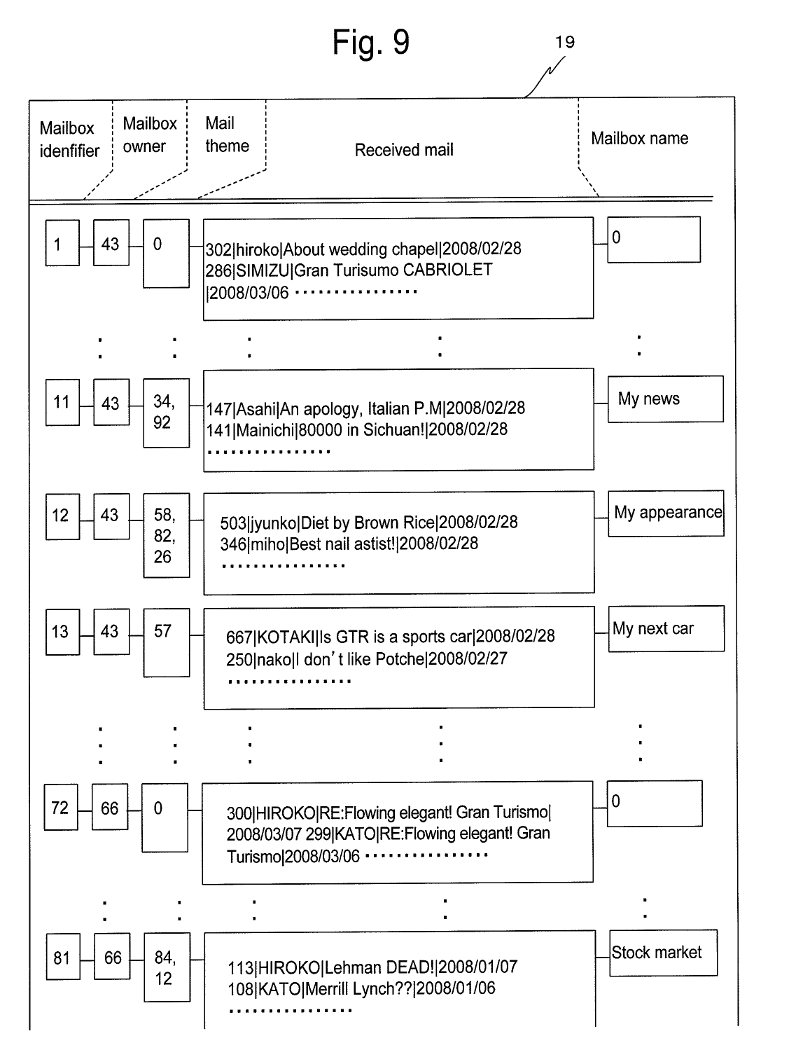

The mailbox storage section 19 holds mailbox information. The two examples of the mailbox information are shown in FIG. 8 and FIG. 9. The first example of the mailbox information is shown in FIG. 8. As shown in FIG. 8, in the first example, individual mailbox information is composed of mailbox identifier, mailbox owner, mail theme, and mailbox name. The second example of the mailbox information is shown in FIG. 9. As shown in FIG. 9, in the second example, the individual mailbox information composed of mail box identifier, mailbox owner, mail theme, received mail, and mailbox name. The form of the individual mailbox information is not limited to the examples described above. In this embodiment, the first example of the mailbox information is employed.

Returning to FIG. 5, the mailbox overview generate section 20 generates mailbox overview information for display at the client terminal 3-x in response to a request for mailbox overview information from the client terminal 3-x through the transmitting/receiving section 6. Then, the mailbox overview generate section 31 transmits the generated mailbox overview information to the client terminal 3-x through the transmitting/receiving section 6.

The mailbox generate section 22 receives a request for mailbox information from the client terminal 3-x through the transmitting/receiving section 6. Subsequently, the mailbox generate section 22 extracts mailbox information corresponding to the received request of mailbox information. Then the mailbox generate section 22 transmits the extracted mailbox information to the client terminal 3-x through the transmitting/receiving section 6.

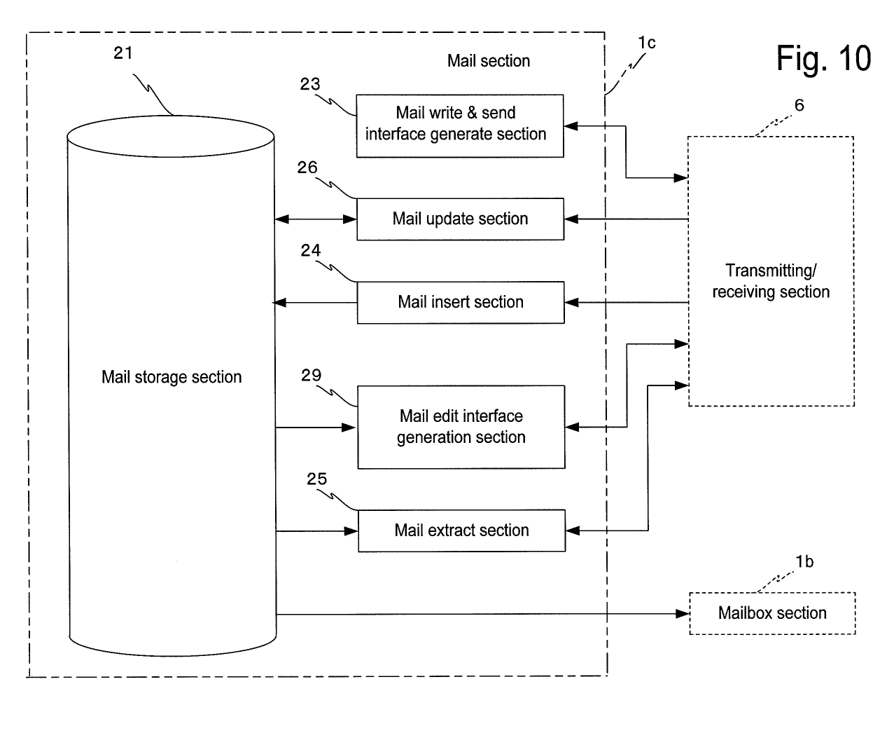

Returning to FIG. 2, the mail section 1c manages e-mails received from the client terminals 3-a, 3-b, . . . . As shown in FIG. 10, this mail section 1c comprises a mail storage section 21, a mail write & send interface generate section 23, and a mail insert section 24. The mail section 1c further comprises a mail extract section 25, a mail update section 26 and a mail edit interface generate section 29.

The mail storage section 21 holds mail information. The example of the mail information is shown in FIG. 11. As shown in FIG. 11, individual mail information is composed of mail identifier, mail sender, mail receiver, mail theme, editable flag, send/update time, mail title, and mail message. The editable flag indicates whether the e-mail is editable or not, after the e-mail is delivered to the mailbox. The form of the individual mail information is not limited to the example as described above.

The mail write & send interface generate section 23 generates mail write & send interface information for displaying at the client terminal 3-x in response to a request of the mail write & send interface information from the client terminal 3-x through the transmitting/receiving section 6. Then the mail write & send interface generate section 23 transmits the generated mail write & send interface information to the client terminal 3-x through the transmitting/receiving section 6.

The mail insert section 24 receives new mail information from the client terminal 3-x through the transmitting/receiving section 6. Then, the mail insert section 24 inserts the new mail information into the mail storage section 21.

The mail extract section 25 receives a request for mail information from the client terminal 3-x through the transmitting/receiving section 6. Subsequently, the mail extract section 25 extracts mail information corresponding to the request of mail information. Then, the mail extract section 25 transmits the extracted mail information to the client terminal 3-x through the transmitting/receiving section 6.

The mail update section 26 receives updated mail information from the client terminal 3-x through the transmitting/receiving section 6. Then, the mail update section 26 updates the mail information in the mail storage section 21, based on the updated mail information.

The mail edit interface generate section 29 generates mail edit interface information for display at the client terminal 3-x in response to a request of the mail edit interface information from the client terminal 3-x through the transmitting/receiving section 6. Then, the mail edit interface generate section 29 transmits the generated mail edit interface information to the client terminal 3-x through the transmitting/receiving section 6.

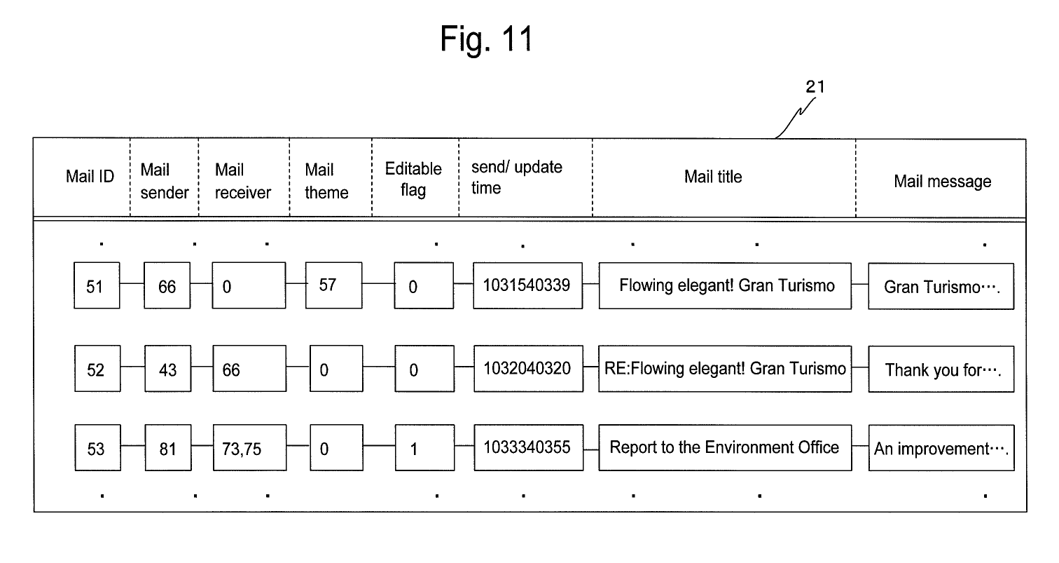

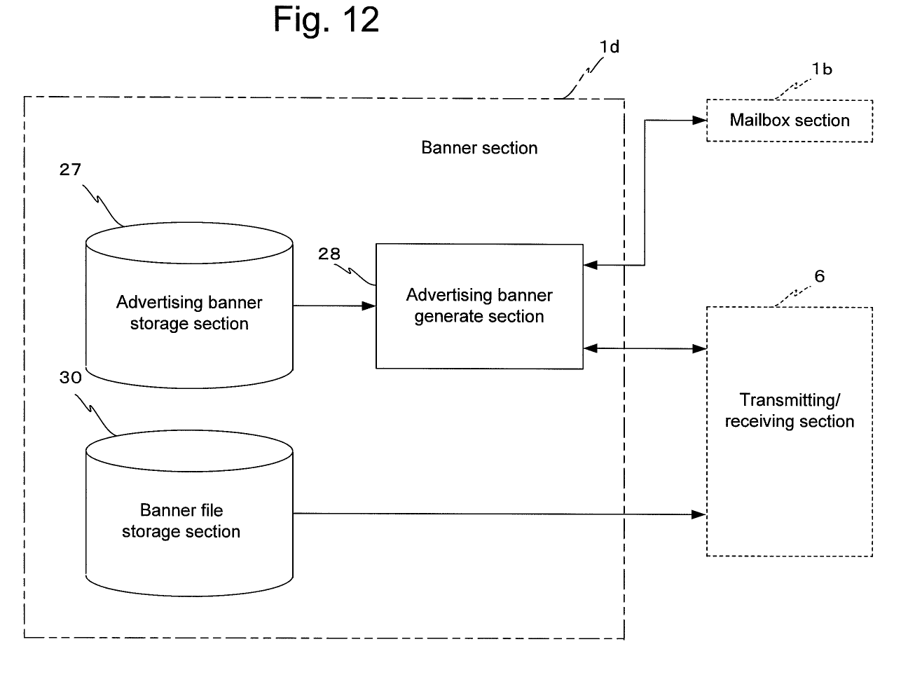

Returning to FIG. 2, the banner section 1d manages banner information. As shown in FIG. 12, this banner section 1d comprises an advertising banner storage section 27, an advertising banner generate section 28, and a banner file storage section 30.

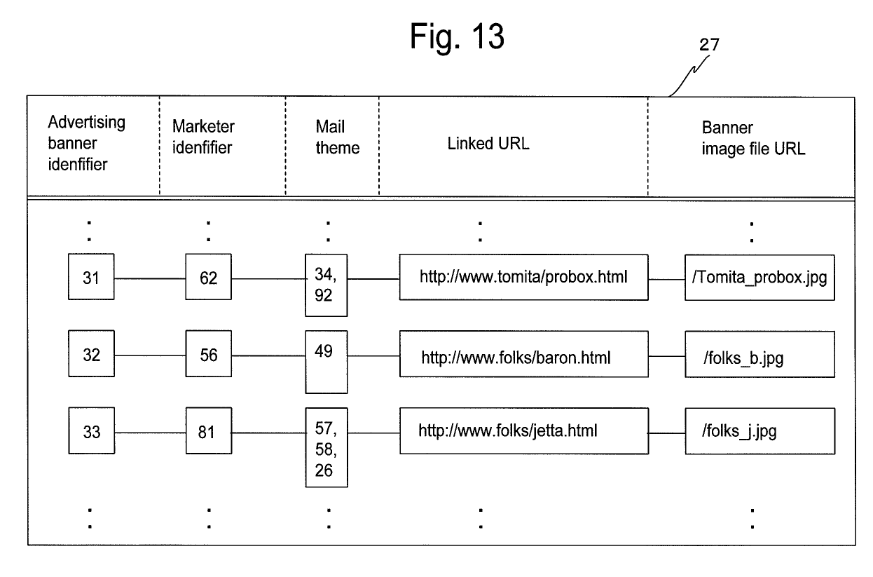

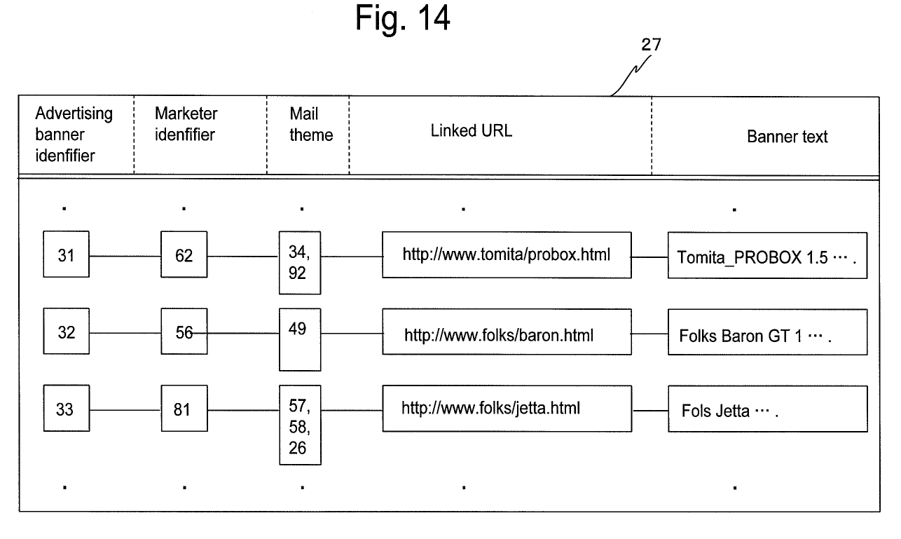

The advertising banner storage section 27 holds banner information. The two examples of the advertising banner information are shown in FIG. 13 and FIG. 14. The first example of the advertising banner information is shown in FIG. 13. As shown in FIG. 13, in the first example, individual advertising banner information is composed of an advertising banner identifier, a marketer identifier, mail theme, linked URL, and banner image file URL. The linked URL is the URL of the web page that is linked to the advertising banner. The second example of the advertising banner information is shown in FIG. 14. As shown in FIG. 14, in the second example, the individual advertising banner information composed of the advertising banner identifier, the marketer identifier, the mail theme, the linked URL, and banner text. The form of the individual advertising banner information is not limited to the example mentioned above.

Returning to FIG. 12, the advertising banner generate section 28 generates banner information for displaying at the client terminal 3-x in response to a request of the banner information from the client terminal 3-x. Then the advertising banner generate section 28 transmits the generated banner information to the client terminal 3-x.

The banner file storage section 30 hold banner image files.

Returning to FIG. 2, the transmitting/receiving section 6 comprises a transmitter and a receiver. The transmitting/receiving section 6 is used, when the mail server 1 communicates with the client terminals 3-a, 3-b, . . . via the internet 2.

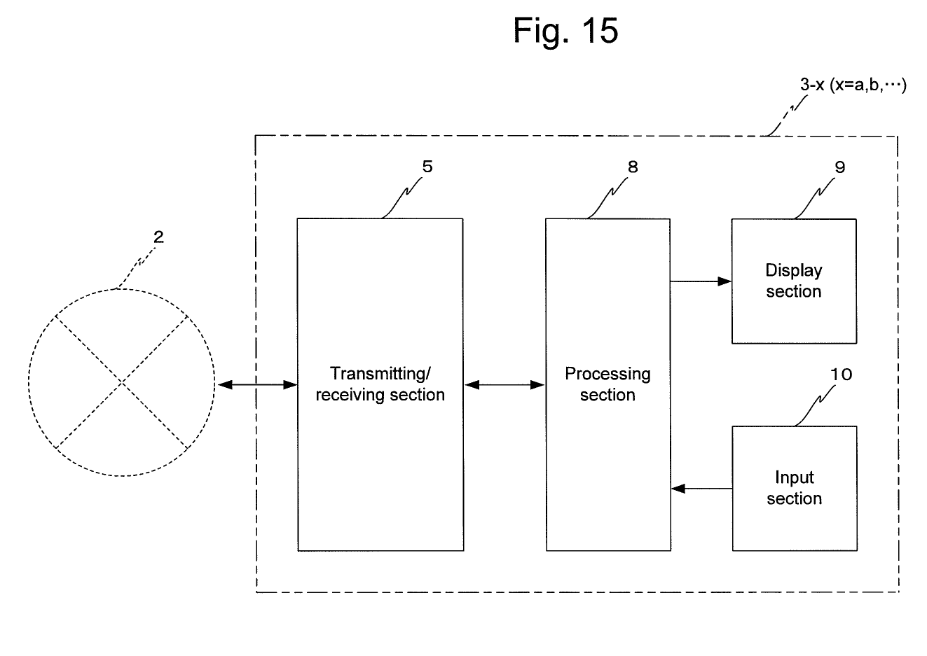

Returning to FIG. 1, the client terminal 3-x (x=a, b, . . . ) is a terminal of one end user who uses the e-mail delivery system 100. As shown in FIG. 15, this client terminal 3-x comprises a transmitting/receiving section 5, a processing section 8, a display section 9, and an input section 10.

The transmitting/receiving section 5 comprises a transmitter section and a receiver section. The transmitting/receiving section 5 is used, when the client terminal 3-x communicates with the mail server 1, or the like via the internet 2.

The processing section 8 performs various processes. The processing section 8 performs processes for transmitting/receiving emails, transmitting various requests to the client server 1, and transmitting/receiving various information between the client terminal 3-x and the mail server 1, according to input result to the input section 10.

As the display section 9, a liquid crystal display panel, an organic EL (Electro Luminescent) panel, PDP (Plasma Display Panel), or the like can be employed. The display section 9 displays various images on a screen under the control by the processing section 8.

As the input section 10, a keyboard, a mouse, a touch panel, or the like can be employed. The input result to the input section 10 is reported to the processing section 8.

<Operation>

Next, the operation of the e-mail delivery system 100 configured as described above is described.

<<End-User Registration Process>>

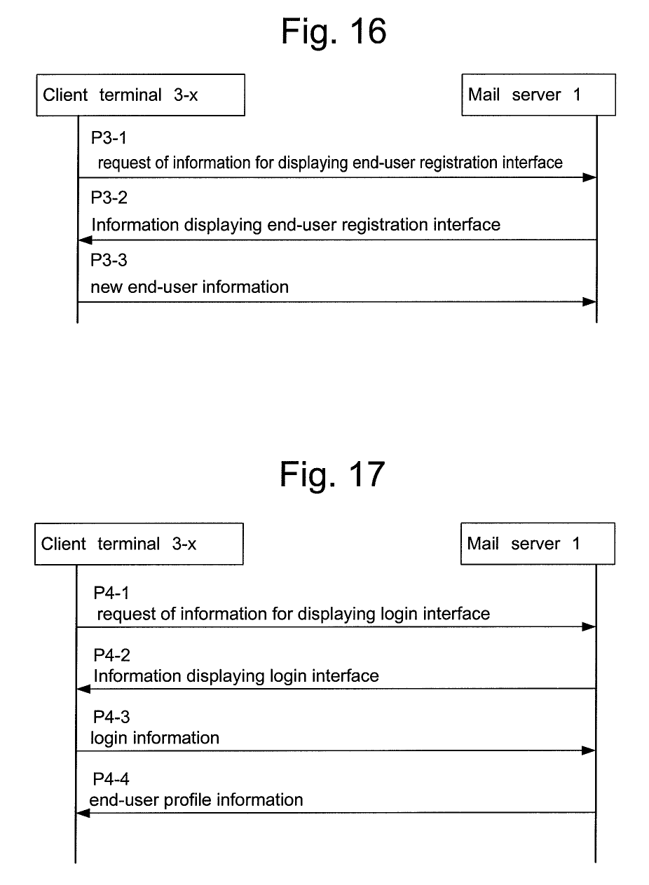

The end-registration process will be described in detail as follows. The network end-user must keep a register of the e-mail delivery end-user. FIG. 16 shows the sequence diagram of the registration process.

As shown in FIG. 16, firstly, the processing section 8 in the client terminal 3-x (x=a, b, . . . ) of network end-user transmits a request of information for displaying the end-user registration interface to the mail sever 1 from the transmitting/receiving section 5 of the client terminal 3-x (P3-1).

In the mail server 1, the register interface generate section 7 receives the request from the client terminal 3-x though the transmitting/receiving section 6. The register interface generate section 7 generates the information to display the end-user registration interface, and transmits the information to the client terminal 3-x through the transmitting/receiving section 6 (P3-2).

In the client terminal, the processing section 8 receives the information to display the end-user registration interface from mail server 1 through the transmitting/receiving section 5. Next, the processing section 8 controls to display the end-user registration interface on a screen in the display section 9.

Then, the end-user inputs new end-user information containing the end-user name, password as end-user collation information, etc. by using the input section 10. Then, the processing section 8 transmits the new end-user information to the mail server 1 through the transmitting/receiving section 5 (P3-3).

In the mail server 1, the end-user Information Insert section 11 receives the new end-user information from the client terminal 3-x through the transmitting/receiving section 6. Then the end-user information Insert section 11 inserts the new end-user information into the end-user information storage section 12.

In this example, collation of information is a password. But the collation of information is not limited to using the password. There are other means for collating the end-user of the client terminal 3-x, such as using a fingerprint, a retina pattern, etc.

Also in this example, the end-user profile contains the end-user identifier and session-key generation based on end-user identifier and login time. But the end-user profile is not limited to this example. There are other means of identifying the end-user of the client terminal 3-x, such as generating a session-key based on end-user identifier, end-user name, and login time.

Further, the scope of the end-user information is not limited to the example mentioned above.

<<Login Process>>

The process of login will be described in detail as follows. The end-user always needs to login to the e-mail delivery system 100 of the present invention when she/he utilize this system. FIG. 17 shows the sequence diagram of the login process.

Firstly, the processing section 8 in the client terminal 3-x of the end-user transmits a request of information for displaying the login interface through the transmitting/receiving section 5 (P4-1). In the mail server 1, the login interface generate section 13 receives the request from the client terminal 3-x through the transmitting/receiving section 6. Then the login interface generate section 13 generates the information to display the login interface and transmits the information to the client terminal 3-x through the transmitting/receiving section 6 (P4-2).

In the client terminal 3-x, the processing section 8 receives the information to display the login interface from the mail server 1 through the transmitting/receiving section 5. Next, the processing section 8 controls to display the login interface on the screen in the display section 9. Then, the end-user inputs the login information containing the end-user name, the password as the end-user collation information, etc. by using the input section 10. Then, the processing section 8 transmits the login information to the mail server 1 through the transmitting/receiving section 5 (P4-3).

In the mail server 1, the authenticate end-user section 14 receives the login information from the client terminal 3-x through the transmitting/receiving section 6. Then the authenticate end-user section 14 extracts the end-user name and the password from the login information and also extracts end-user name and password linked to the end-user name from the end-user information storage section 12. Subsequently, the authenticate end-user section 14 compares the password of the login information with the password extracted from the end-user information storage section 12.

If the password of login information is the same as that extracted from the end-user information storage section 12, then the authenticate end-user section 14 validates the end-user. Subsequently, the authenticate end-user section 14 generates the end-user profile which contains end-user identifier and session-key generation based on the end-user identifier and login time. Next, the authenticate end-user section 14 inserts the end-user profile into the end-user information storage section 12. Then, the authenticate end-user section 14 transmits the end-user profile to the client terminal 3-x through the transmitting/receiving section 6 (P4-4). When the processing section 8 receives the end-user profile, the processing section 8 holds it.

In this example, the end-user profile contains the end-user identifier and session-key generation based on the end-user identifier and login time.

After login, the processing section 8 in the client terminal 3-x transmits, to the mail server 1, various requests with the user profile for accessing the mail server. When the authenticate end-user section 14 receives the user profile in a request from the client terminal 3-x through the transmitting/receiving section 6. Then, the authenticate end-user section 14 extracts the end-user identifier from the received end-user profile and reads the end-user profile corresponding to the extracted end-user identifier. Subsequently, the authenticate end-user section 14 compares the end-user profile from the client terminal 3-x with the end-user profile read out from the end-user information storage section 12.

If the end-user profile from the client terminal 3-x is the same as that read out from the end-user information storage section 14, the authenticate end-user section 14 then validates the end-user and extracts the end-user name from the end-user information storage section 12. Usually the end-user profile is saved as a cookie at the client terminal. But it is not limited as such. Other types of identifier are also available.

<<Mail Box Setting Up Process>>

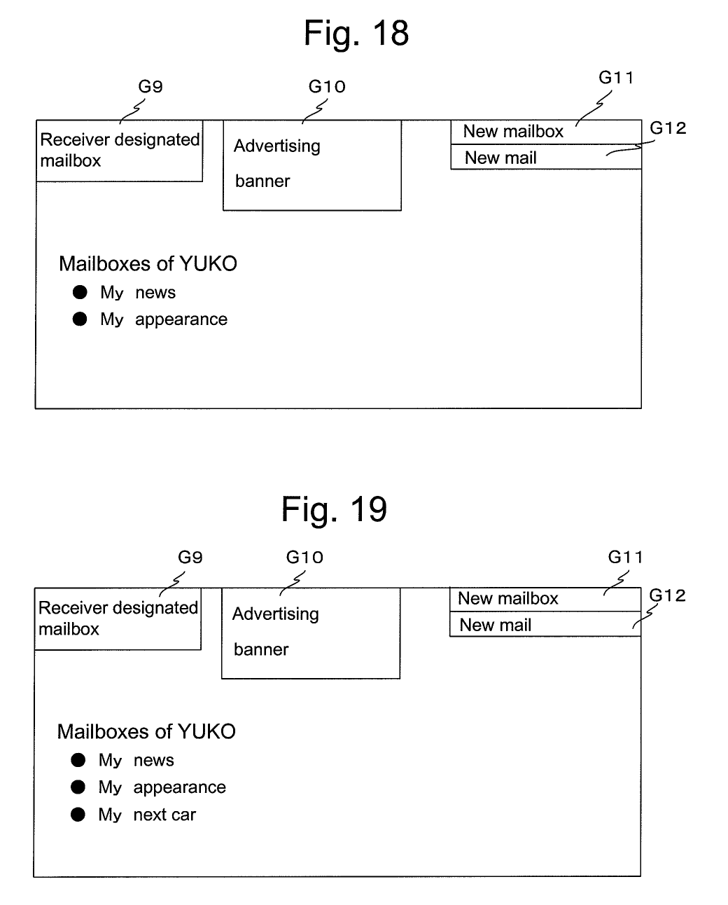

In the followings, it is assumed that the end-user whose name is ‘YUKO’ sets up a new mailbox “My next car”. FIG. 18 shows the mailbox overview displayed on the screen in the display section 9 before ‘YUKO’ sets up the ‘My next car’. FIG. 19 shows the mailbox overview displayed on the screen in the display section 9 after ‘YUKO’ sets up the ‘My next car’. As shown in FIGS. 18 and 19, the mailbox overview contains the ‘Receiver Designated Mailbox’ button (G9), the ‘New Mailbox’ button (G11) and the ‘New Mail’ button (G12), as well as a visual recap of the mailbox name. In this embodiment, as shown in FIGS. 18 and 19, the mail box further contains the ‘Advertising Banner’ button (G10) and a visual recap of the mailbox name. In this example, the visual recap of the mailbox name is a list.

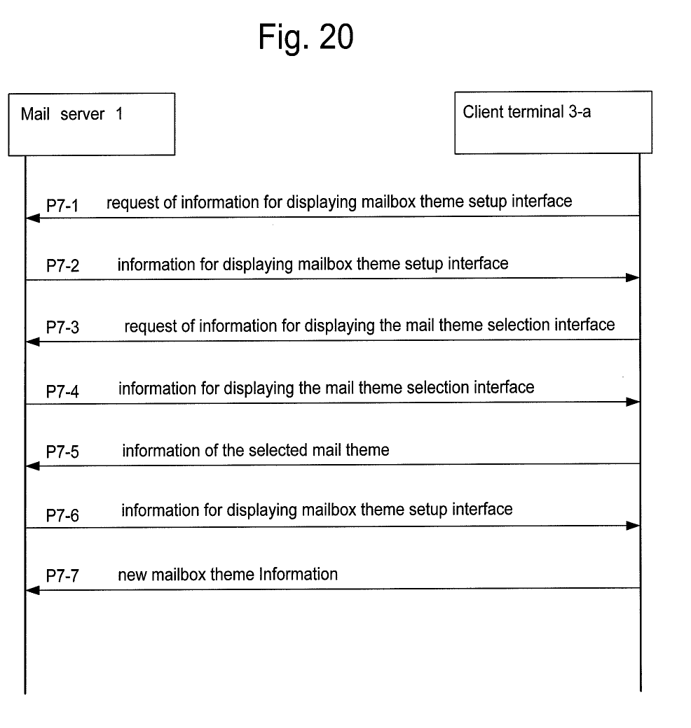

The process for setting up the mailbox will be described in detail as follows. FIG. 20 is the sequence diagram of the mail box setting up process (steps P7-1 to P7-7). Initially, it is assumed that the mailbox overview as shown in FIG. 18 is displayed on the screen in the display section 9.

Firstly, the end-user “YUKO” clicks the ‘New Mailbox’ button (G11) by using the input section 10. Then processing section 8 in the client terminal 3-a transmits a request of information for displaying the mailbox setup interface to the mail server 1 through the transmitting/receiving section 5 (P7-1).

In the mail server 1, the mailbox setup interface generate section 15 and the authenticate end-user section 14 receives the request with the end-user profile from the client terminal 3-a through the transmitting/receiving section 6. Then, the mailbox setup interface generate section 15 gets the end-user identifier and end-user name from the authenticate end-user section 14, and generates information to display the mailbox setup interface. Subsequently, the mailbox setup interface generate section 15 transmits the generated information to display the mailbox setup interface to the client terminal 3-x through the transmitting/receiving section 6 (P7-2).

In the client terminal, the processing section 8 receives the information for display the mailbox setup interface form the mail server 1 through the transmitting/receiving section 5.

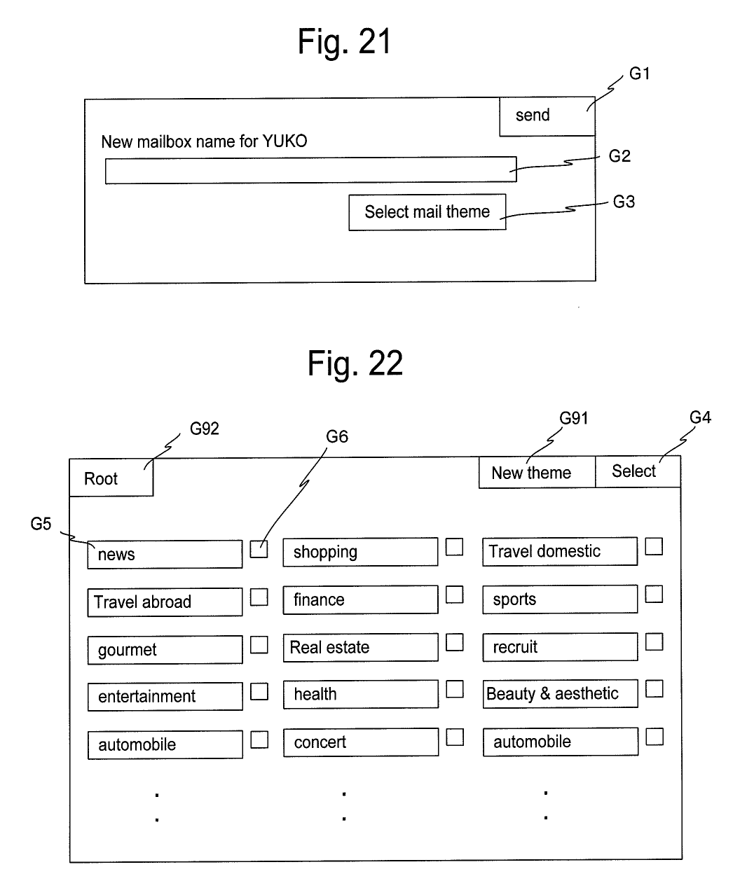

Then, the processing section 8 controls so as to display the mailbox setup interface on the screen in the display section 9. The example of the mailbox setup interface is shown in FIG. 21. As shown in FIG. 21, the mailbox setup interface contains the ‘send’ button (G1), the mailbox name input region (G2), and the ‘Select mail theme’ button (G3).

Next, the end-user clicks the ‘Select mail theme’ button (G3) for selecting the mail theme of new mailbox by using the input section 10. Return to FIG. 20, then, the processing section 8 transmits a request of information for displaying mail theme selection interface to the mail server 1 through the transmitting/receiving section 5 (P7-3).

In the mail server 1, the mail theme selection interface generate section 16 and the authenticate end-user section 14 receive the request with the end-user profile from the client terminal through the transmitting/receiving section 6. Subsequently, the mail theme selection interface generate section 16 gets the end-user identifier and the end-user name from the authenticate end-user section 14, and generates the information for displaying the mail theme selection interface, based on the information extracted from the mail theme storage section 17.

Then, the mail theme selection interface generate section 31 transmits the information for displaying the mail theme selection interface to the client terminal 3-a through the transmitting/receiving section 6 (P7-4).

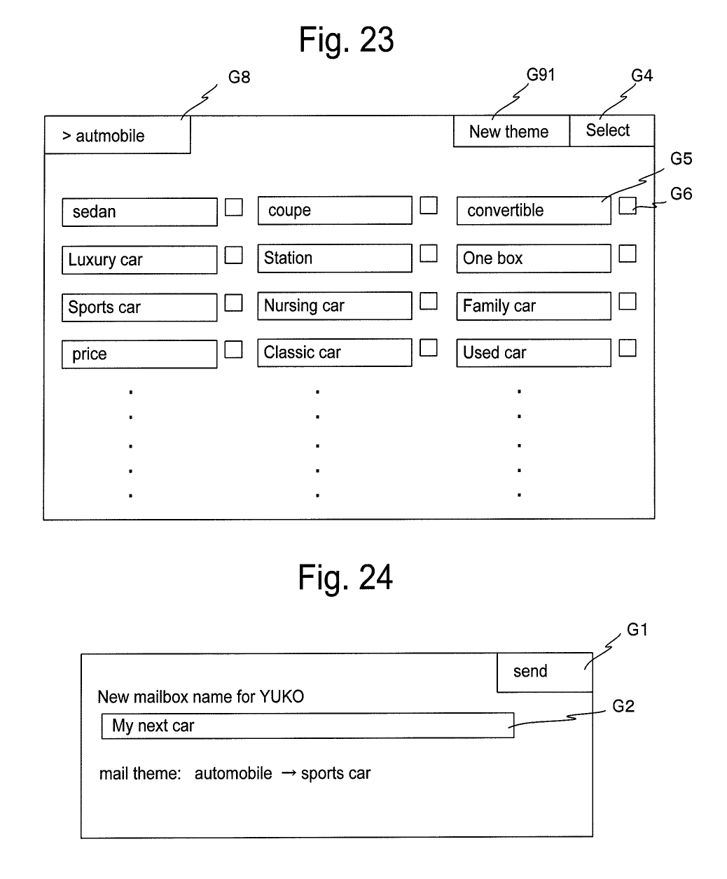

In the client terminal 3-a, the processing section 8 receives the information for displaying the mail theme selection interface form the mail server 1 through the transmitting/receiving section 5. Then, the processing section 8 controls so as to display the mail theme selection interface on the screen in the display section 9. The example of the mail theme selection interface is shown in FIG. 23. As shown in FIG. 23, the mail theme selection interface contains ‘Select’ button (G4), ‘Theme Name’ button (G5), ‘Checkbox’ (G6), ‘Go Back’ button (G8), and ‘New Theme’ button (G91).

Returning to FIG. 22, if the end-user selects a mail theme by clicking ‘Checkbox’ (G6) and then clicking ‘Select’ button (G4), the processing section 8 transmits the selected mail theme to the mail server 1 through the transmitting/receiving section 5 (P7-5).

If the end-user clicks the ‘Theme Name’ button (G5), the processing section 8 transmits a request of information for displaying another (child) mail theme selection interface to the mail server 1 through the transmitting/receiving section 5 (P7-3).

In the mail server 1, the mail theme selection interface generate section 16 and the authenticate end-user section 14 receive the request with the end-user profile from the client terminal through the transmitting/receiving section 6. Subsequently, the mail theme selection interface generate section 16 gets the end-user identifier and end-user name from the authenticate end-user section 14, and generates the information for displaying another mail theme selection interface, based on the information extracted from the mail theme storage section 17. Then, the mail theme selection interface generate section 31 transmits the information for displaying the mail theme selection interface to the client terminal 3-a through the transmitting/receiving section 6 (P7-4).

In the client terminal 3-a, the processing section 8 receives the information for displaying another mail theme selection interface from the mail server 1 through the transmitting/receiving section 5. Then, the processing section 8 controls so as to display another mail theme selection interface on the screen in the display section 9. The example of another mail theme selection interface is shown in FIG. 23.

In this example, the end-user clicked the ‘Theme Name’ button (G5), ‘Automobile’, in the mail theme selection interface shown in FIG. 22. As a result, the Mail Theme Selection interface shown in FIG. 23 shows the sub mail theme of the parent mail theme, ‘Automobile’.

If the end-user wants to go back to the mail theme selection interface as shown in FIG. 22 and clicks on the ‘Go Back’ button (G8) in the mail theme selection interface as shown in FIG. 23, the processing section 8 transmits a request for information to display the parent mail theme selection interface to the mail server 1 through the transmitting/receiving section 5 (P7-3). Then, the processes mentioned above are carried out and the mail theme selection interface as shown in FIG. 23 is displayed on the screen in the displaying section 9.

In this example, end-user ‘YUKO’ clicks ‘Checkbox’ (G6) of ‘Sports Car’ and clicks ‘Select’ button (G4) in the Mail Theme Selection interface (FIG. 23). Then, the processing section 8 transmits the selected mail theme to the mail server 1 through the transmitting/receiving section 5 (P7-5).

Since the process of selecting the mail theme mentioned above can be repeated as needed, one or more mail themes can be selected in this process when the end-user writes a new mail, sets up a new mailbox, and creates a new mail theme.

In the mail server 1, the mailbox insert section 18 and the authenticate end-user section 14 receive the information of the selected mail theme containing the selected mail theme identifier and the end-user profile from the client terminal 3-a through the transmitting/receiving section 6. Next, the mailbox insert section 18 gets the end-user identifier and end-user name from the authenticate end-user section 14, and inserts new mailbox information (the information of the mailbox by which the mailbox is displayed at the client terminal) containing the selected mail theme identifier and the end-user identifier into the mailbox storage section 19.

A new mailbox identifier is inputted in the column ‘Mailbox identifier’ in FIG. 8 or FIG. 9 automatically. The selected mail theme identifier is saved in the column ‘Mail Theme’ and the end-user identifier is saved in the column ‘Mailbox owner’ in FIG. 8 or FIG. 9. The process of selecting a mail theme can be repeated several times for adding a mail theme identifier to the column ‘Mail theme’ in FIG. 8 or FIG. 9.

The mail theme identifier is always added. The mailbox setup interface generate section 15 extracts the new mailbox information containing information about the selected mail theme identifier and the end-user identifier, extracts the end-user name from the end-user information in the end-user information storage section 12 by searching the column ‘End-user identifier’, using the end-user identifier, and extracts the mail theme name from the mail theme information in the mail theme storage section 17 by searching the column ‘Mail theme identifier’, using the selected mail theme identifier.

Then, the mailbox setup interface generate section 15 generates the information for displaying the mailbox setup interface containing the end-user name and the selected mail theme name. Subsequently, the mailbox setup interface generate section 15 transmits the generated information to the client terminal through the transmitting/receiving section 6 (P7-6).

In the client terminal, the processing section 8 receives the information for displaying the mailbox setup Interface containing the selected mail theme from the mail server 1 through the transmitting/receiving section 5. Then, the processing section 8 controls so as to display the mailbox setup interface containing the selected mail theme as shown in FIG. 24.

Next, ‘YUKO’ inputs the mailbox name of the new mailbox into the mail name input region (G2) and clicks the ‘Send’ button (G1) by using the input section 10. Then the processing section 8 transmits the new mailbox information to the mail server 1 through the transmitting/receiving section 5 (P7-7). In this example, the name of the new mailbox is ‘My Next Car’ and its mail theme is ‘Sports Car’ (‘Automobile>Sports Car’). This mailbox relates to the mail which has the mail theme ‘Sports Car’.

In the mail server 1, the mailbox insert section 18 receives the new mailbox information and the end-user profile from the client terminal through the transmitting/receiving section 6. Then, the mailbox insert section 18 inserts the information into the column ‘Mailbox owner’, and ‘Mailbox name’ of the new mailbox information in the mailbox storage section.

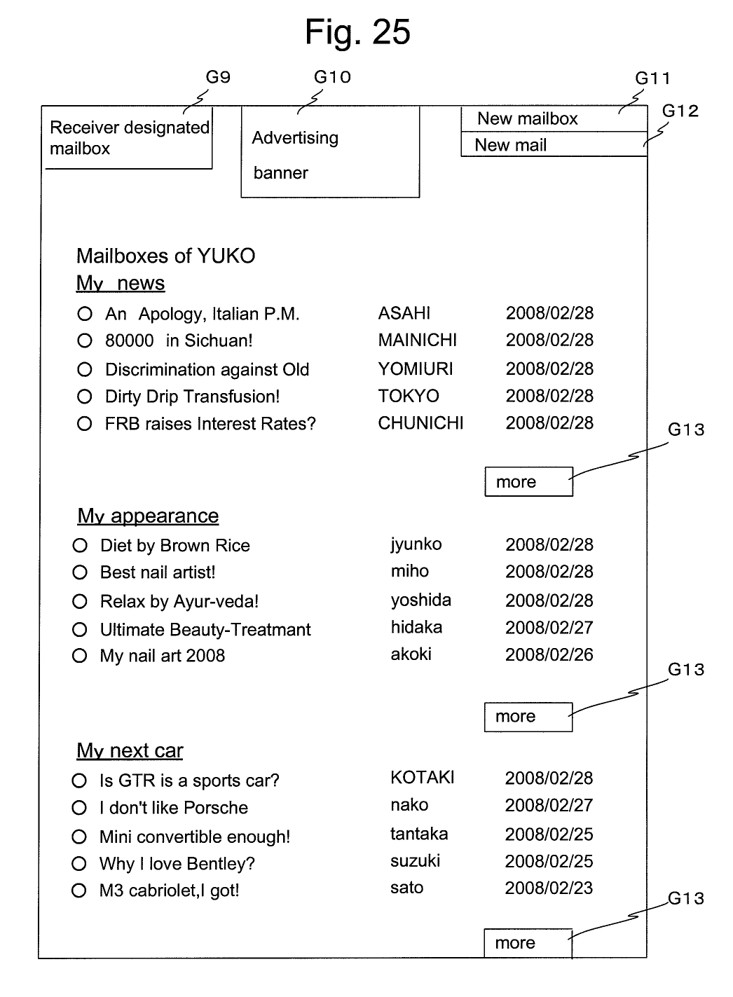

FIG. 25 shows another style of mailbox overview. In FIG. 25, the mailbox names and mail titles contained in the mailbox are shown. When the mailbox owner clicks the ‘More’ button (G13) in FIG. 25, the mailbox is displayed.

<<Creating Mail Theme Process>>

The mail theme Selection interface shown in FIG. 22 is displayed as mentioned above in. The mail theme in the mail theme selection interface is created by the end-user of the client terminal.

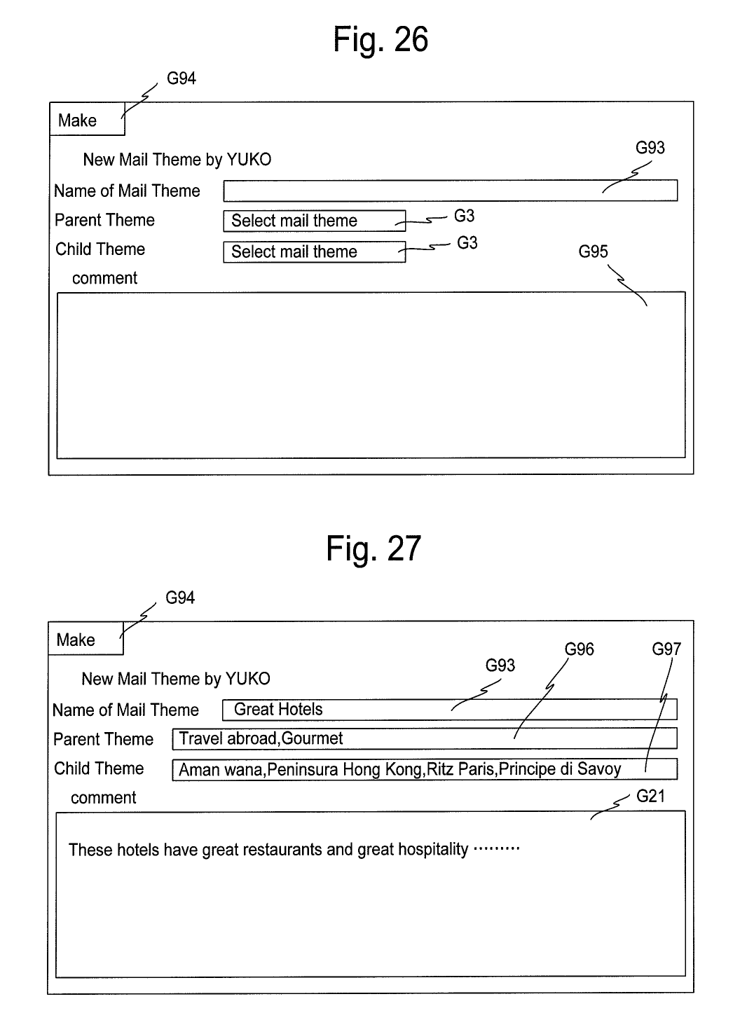

In the followings, it is assumed that the end-user ‘YUKO’ creates a new mail theme. FIG. 26 shows the mail theme setup interface, which contains the name of the end-user ‘YUKO’, the name of mail theme input area (G93), the ‘Make’ button (G94), the ‘Select Mail Theme’ button (G3) for selecting the parent theme, ‘Select Mail Theme’ button (G3) for selecting the child theme, and the comment input area (G95). The form of mail theme setup interface is not limited to the example mentioned above.

FIG. 27 shows the mail theme setup interface after the parent mail theme(s) and the child mail theme(s) are selected. Also, the name of the new mail theme and comment about the new mail theme are inputted. The name of new mail theme ‘Great Hotels’, the parent mail themes ‘Travel Abroad, Gourmet’, the child mail themes ‘Aman Wana, Peninsura Hong Kong, Ritz Paris, Principe di Savoy’ are shown.

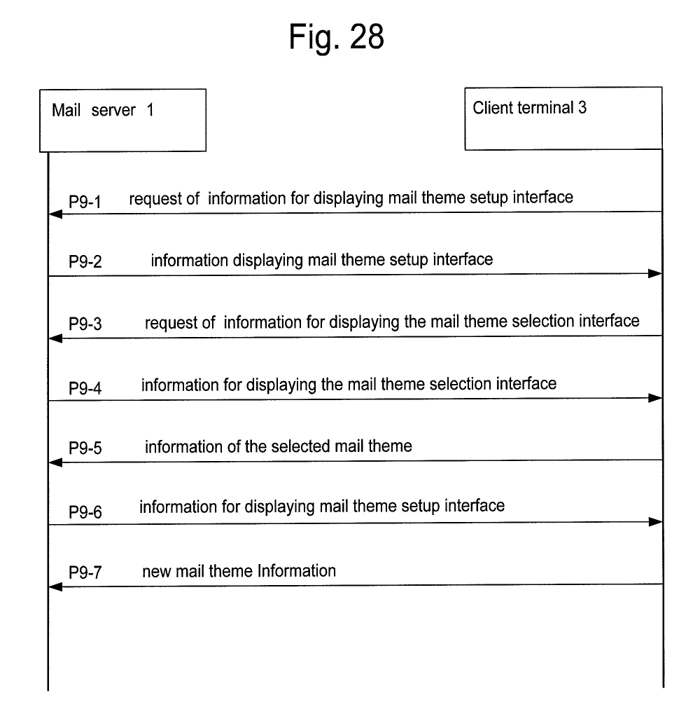

The process of creating the mail theme by the end-user will be described in detail as follows. FIG. 28 is the sequence diagram of the creating mail theme process (steps P9-1 to P9-7). Initially, it is assumed that the mail theme selection interface as shown in FIG. 22 is displayed on the screen in the display section 9.

The end-user clicks the ‘New Theme’ button (G91) in the mail theme selection interface by using the input section 10. Then, the processing section 8 transmits a request for information for displaying the mail theme setup interface to the mail server 1 through the transmitting/receiving section 5 (P 9-1).

In the mail server 1, the mail theme setup interface generate section 31 and the authenticate end-user section 14 receive the request with end-user profile from the client terminal 3-a through the transmitting/receiving section 6. Subsequently, the mail theme setup interface generate section 31 gets the end-user identifier and end-user name from the authenticate end-user section 14, and generates the information for displaying the mail theme setup interface. Then, the mail theme setup interface generate section 31 transmits the generated information to the client terminal 3-a through the transmitting/receiving section 6 (P 9-2).

In the client terminal 3-a, the processing section 8 receives the information for displaying the mail theme setup interface from the mail server 1 through the transmitting/receiving section 5. Then, the processing section 8 controls so as to display the mail theme setup interface shown in FIG. 26 on the screen in the display section 9.

The end-user clicks ‘select mail theme’ button (G3) for selecting the parent theme of new theme and another ‘select mail theme’ button (G3) for selecting the child theme of the new theme using the input section.

Next, a process corresponding to step P9-3 to P9-5, which is similar to the process corresponding to step P7-3 to P7-5 mentioned above, is performed. The difference between these processes is that the end-user clicks ‘Root’ button (G92) in the mail theme selection interface shown in FIG. 22, when the end-user wishes to create a new mail theme under the root.

In the mail server 1, the mail theme insert section 32 and the authenticate end-user section 14 receive information containing a selected mail theme and the end-user profile from the client terminal 3-a through the transmitting/receiving section 6. Subsequently, the mail theme setup interface generate section 31 gets the end-user identifier from the authenticate end-user section 14, and inserts new mail theme information containing the selected mail theme identifier and the end-user identifier into the mail theme storage section 17.

In this example, the new mail theme identifier (in this example, ‘507’) is inputted in the column ‘mail theme identifier’ in new mail theme information automatically. The end-user identifier is saved in the column ‘Theme Owner’. When the end-user intends to select a mail theme as the parent theme, the selected mail theme identifier is saved in the column ‘Parent theme’. When the end-user intends to select a mail theme as the child theme, the selected mail theme identifier is saved in the column ‘Child Theme’. The process of selecting a mail theme can be repeated several times for adding the mail theme identifier to the column ‘Parent Theme’ or ‘Child Theme’.

The mail theme identifier(s) is always added. The mail theme setup interface generate section 31 extracts the new mail theme information containing information about the selected mail theme identifier(s) and the end-user identifier, and extracts the end-user name from the end-user information in the end-user information storage section 12 by searching the column ‘End-user identifier’, using the end-user identifier, and extracts the mail theme name from the mail theme information in the mail theme storage section 17 by searching the column ‘Mail theme identifier’, using the selected mail theme identifier.

Next, the mail theme setup interface generate section 31 generates the information to display the mail theme Setup interface, based on the new mail theme information. Then, mail theme setup interface generate section 31 transmits the generated information to the client terminal 3-a through the transmitting/receiving section 6 (P9-6).

In this example, the mail theme identifiers ‘4’, and ‘7’ that correspond to ‘Travel Abroad’ and ‘Gourmet’ are inputted in the column ‘Parent Theme’, and the mail theme identifiers ‘214’, ‘285’, ‘186’, and ‘195’ that respectively correspond to ‘Aman Wana’, ‘Peninsura Hong Kong’, ‘Ritz Paris’, and ‘Principe di Savoy’ are inputted in the column ‘Child Theme’. The end-user identifier ‘43’ that corresponds to ‘YUKO’ is inputted in the column ‘Theme Owner’.

In the client terminal 3-a, the processing section 8 receives the information for displaying the mail theme setup interface from the mail server 1 through the transmitting/receiving section 5. Then, processing section 8 controls to display the mail theme setup interface (FIG. 27), on the screen in the display section 9.

The end-user clicks the ‘Make’ button (G94) in the mail theme setup interface shown in FIG. 27 by using the input section 10. Returning to FIG. 28, the processing section 8 transmits a new mail theme information containing new mail theme identifier, the parent theme(s), the child theme(s), the theme owner, and the mail theme name to the mail server 1 through the transmitting/receiving section 5 (P 9-7).

In the mail server, the mail theme insert section 32 receives the new mail theme information from the client terminal 3-a through the transmitting/receiving section 6. Next, the mail theme insert section 32 inserts ‘Mail theme name’ and the comment into the columns of the new mail theme information. The parent theme(s), the child theme(s), and the theme owner are already inputted.

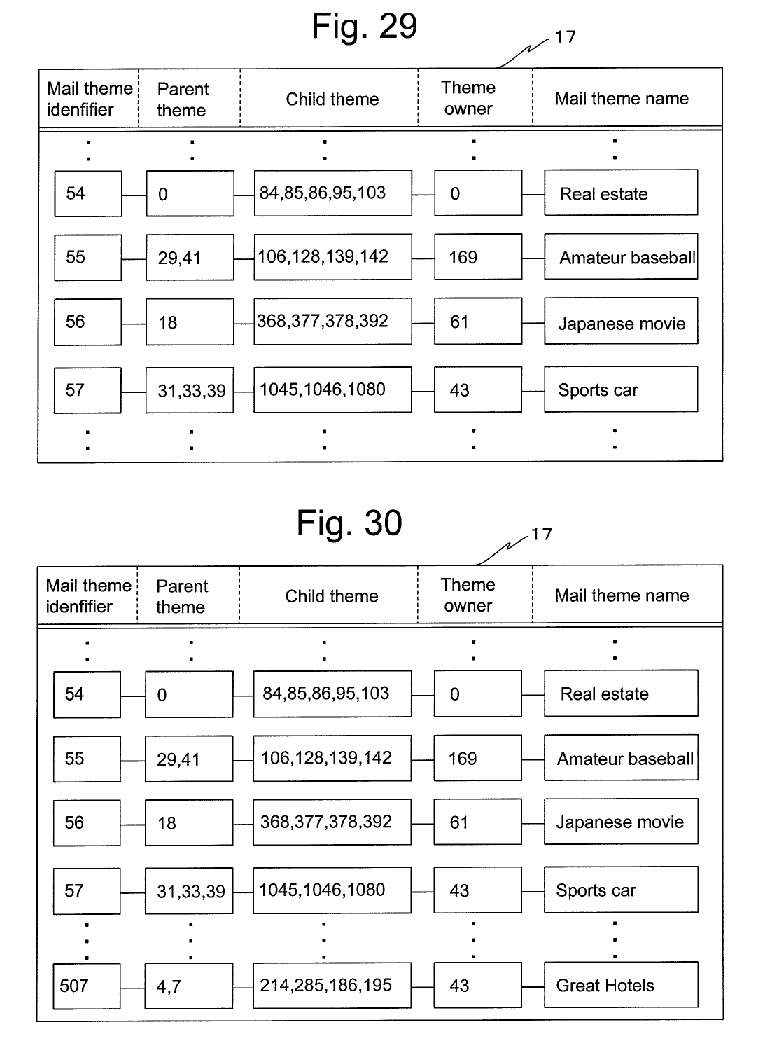

FIG. 29 and FIG. 30 show examples of the contents in mail theme storage section 17. In FIG. 29 and FIG. 30, each individual mail theme information contains the column ‘Mail theme identifier’, the column ‘Parent theme’, the column ‘Child theme’, the column ‘Theme owner’ and the column ‘Mail theme name’. FIG. 29 shows the mail theme storage section 17 before the new mail theme ‘Great Hotels’ is created, and FIG. 30 shows the mail theme storage section 17 after the new mail theme ‘Great Hotels’ is created. In FIG. 29 and FIG. 30, there is no column ‘comment’. It is only because of lack of space in these diagrams.

FIG. 29 shows the mail theme storage section 17 before the new mail theme ‘Great Hotels’ is created, and FIG. 30 shows the mail theme storage section 17 after the new mail theme ‘Great Hotels’ is created.

<<Mailbox Overview Displaying Process>>

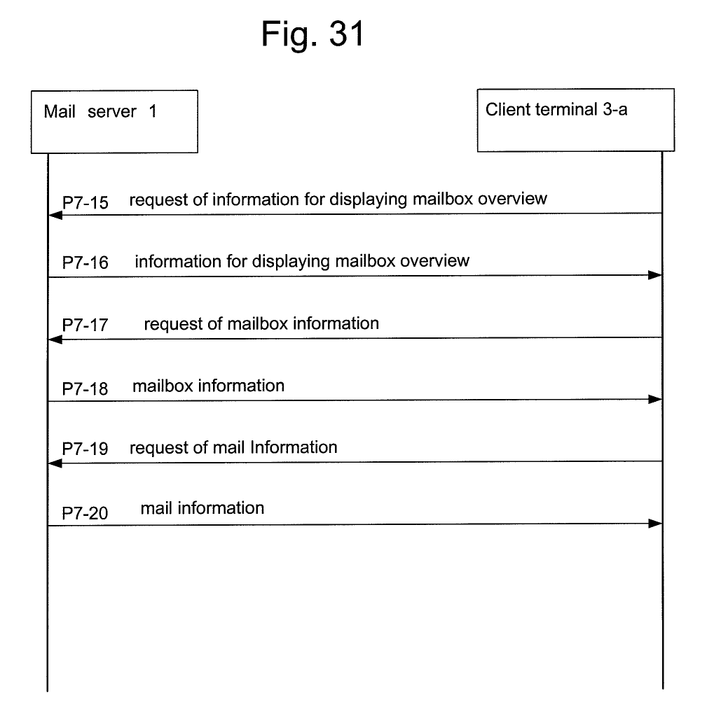

The process of displaying the mailbox overview will be described in detail as follows. FIG. 31 is the sequence diagram of the mailbox overview displaying process (steps P7-15 to P7-16). In the following, it is assumed that the end-user ‘YUKO’ browses the mailbox overview.

The processing section 8 in the client terminal 3-a transmits a request for information for displaying the mailbox overview with the end-user profile to the mail server 1 through the transmitting/Receiving section 5 (P7-15). In the mail server 1, the mailbox overview generate section 20 and the authenticate end-user section 14 receive the request from the client terminal 3-a through the transmitting/receiving section 6. Subsequently, the mailbox overview generate section 20 gets the end-user identifier and the end-user name from the authenticate end-user section 14.

Then, the mailbox overview generate section 20 selects the mailbox information where the column ‘Mailbox owner’ is the same as the end-user identifier of the client terminal 3-a in the mailbox storage section 19 and extracts the relevant mailbox information (i.e., the mailbox identifier, the mailbox owner, the mailbox name). Subsequently, the mailbox overview generate section 20 generates the information to display the mailbox overview. The mailbox overview generate section 20 transmits the generated information to the client terminal 3-a through the transmitting/receiving section 6 (P7-16).

In the client terminal 3-a, the processing section 8 receives the information to display the mailbox overview from the mail server 1 through the transmitting/receiving section 5. Then the processing section 8 controls so as to display the mailbox overview. As described above, the examples of the mailbox overview are shown in FIG. 18 and FIG. 19.

The mailbox contains the mailbox name, the mail theme, the mailbox owner name, and the mail titles. All e-mail related to this mailbox was made before the mailbox was set up. This is because the mailbox ‘My Next Car’ is opened for the first time. This means that the mailbox always collects e-mails existing in the network by using the selected mail theme. The method for collecting e-mails by using a specified mail theme will be described in detail as follows.

<<Mailbox and E-Mail Displaying Process>>

The process of mailbox and e-mail displaying is shown on P7-17 to P7-20 in FIG. 31.

When the end-user ‘YUKO’ clicks the mailbox name ‘My Next Car’ in FIG. 19 by using the input section 10, the processing section 8 transmits a request for information to display the mailbox ‘My Next Car’ to the client terminal 1 through the transmitting/receiving section 5 (P7-17). The request for information to display the mailbox ‘My Next Car’ contains the mailbox identifier.

In the mail server 1, the mailbox generate section 22 and the authenticate end-user section 14 receive the request from the client terminal 3-a through the transmitting/receiving section 6. Subsequently, the mailbox generate section 22 gets the end-user identifier and the end-user name from the authenticate end-user section 14, and extracts the mailbox identifier from the request received, and then select the mailbox information in the mailbox storage section 19 by using the mailbox identifier. The mailbox generate section 22 extracts the mail theme from the selected mailbox information.

Next, the mailbox generate section 22 accesses the mail storage section 19 and selects the mail information that matches the same mail theme as the extracted mail theme. Then the mailbox generate section 22 extracts information related to the mail identifier, mail sender, send/update time, and mail title. Subsequently, the mailbox generate section 22 generates information to display the mailbox ‘My Next Car’ that contains the mail identifiers, the mail senders, the send/update times, and the mail titles. Then, the mailbox generate section 22 transmits the information for displaying the mailbox ‘My Next Car’ to the client terminal 3-a through the transmitting/receiving section 6 (P7-18).

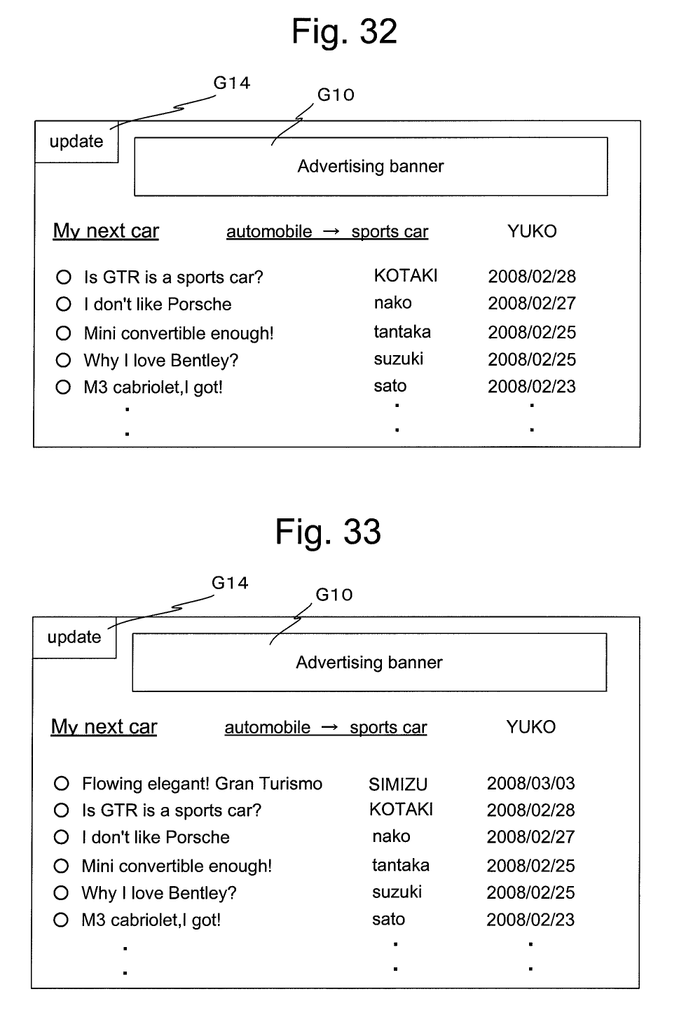

In the client terminal 3-a, the processing section 8 receives the information displaying the mailbox ‘My Next Car’ from the mail server through the transmitting/receiving section 6. Then, the processing section 8 controls so as to display the mailbox ‘My Next Car’ on the screen in the display section 9. The examples of the mailbox ‘My Next Car’ are shown in FIG. 32 and FIG. 33.

Returning to FIG. 31, when the end-user ‘YUKO’ clicks the mail title ‘Is GTR a Sports Car’ in the mailbox ‘My Next Car’ in FIG. 32, the processing 8 transmits a request for the mail information containing mail identifier with the end-user profile to the mail server 1 through the transmitting/receiving section 5 (P7-19).

In the mail server, the mail extract section 25 receives the request from the client terminal 3-a through the transmitting/receiving section 6. Next, the mail extract section 25 extracts the mail identifier from the request for mail information. Subsequently, the mail extract section 25 selects the mail information in the mail storage section 21 by using the mail identifier. Then the mail extract section 25 transmits the selected mail information to the client terminal 3-a through the transmitting/receiving section 6 (P7-20).

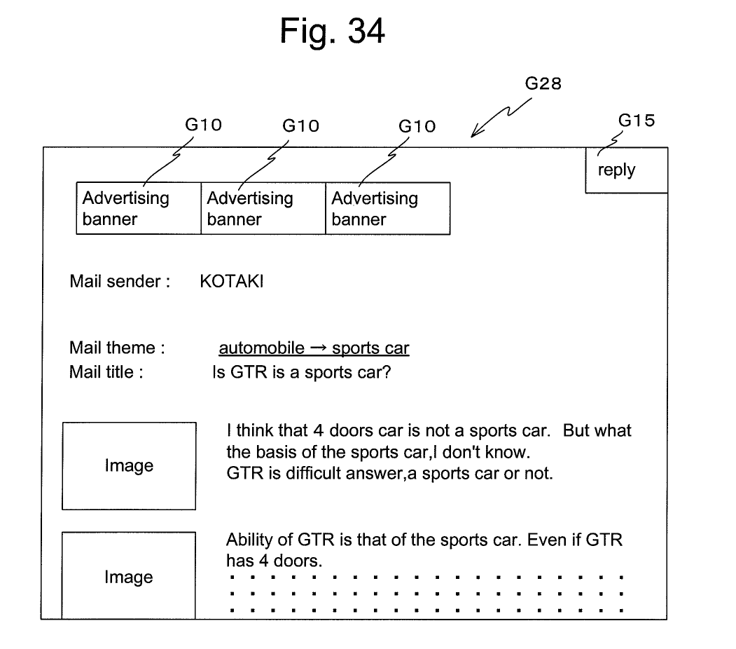

In the client terminal 3-a, the processing section 8 receives the mail information from the mail server 1 through the transmitting/receiving section 6. Then, the processing section 8 controls so as to display the mail ‘Is GTR a Sports Car’ on the screen in the display section 9. The example of the mail ‘Is GTR a Sports Car’ is shown in FIG. 34. In this example the mail ‘Is GTR a Sports Car ’ has the same mail theme as the mailbox ‘My Next Car’. The mail theme is ‘Sports Car’ (‘Automobile>Sports Car’).

<<Mail Creating Process>>

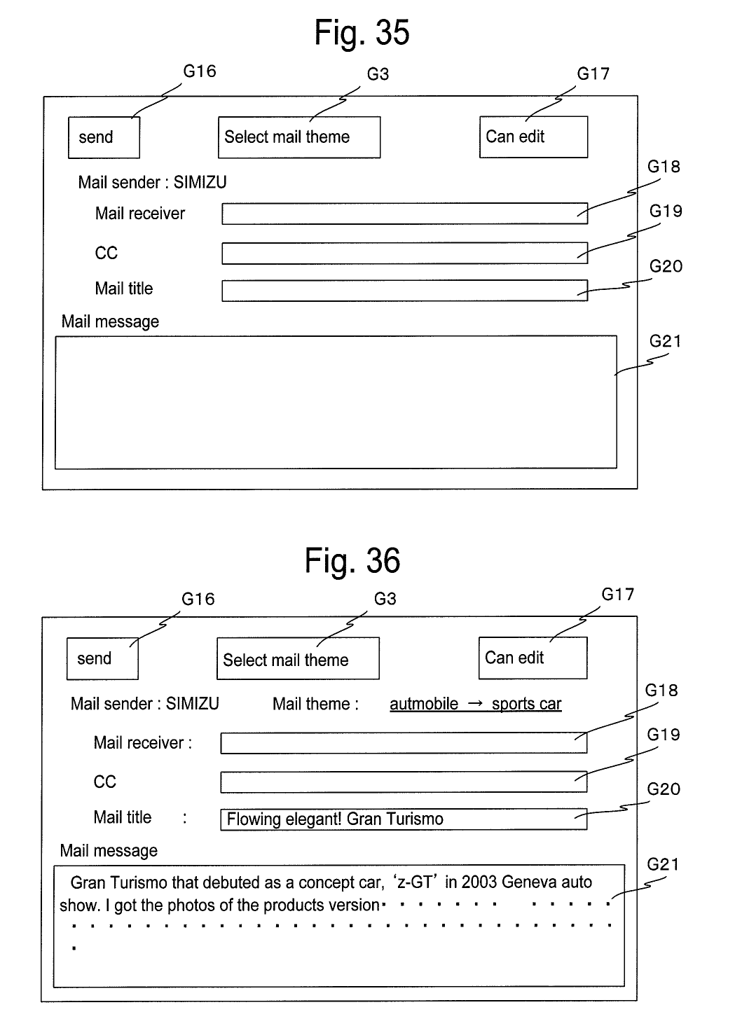

In the following, it is assumed that the end-user ‘SIMIZU’ creates a new mail with mail theme. FIG. 35 shows the example of a mail write & send interface displayed in the display section 9 of the client terminal 3-b. FIG. 36 shows the mail write & send interface in which the selected mail theme is displayed. As shown in FIGS. 35 and 36, the write & send interface contains the mail sender's name ‘SIMIZU’, the ‘Send’ button (G16), the ‘Select Mail Theme’ button (G3), the ‘Can Edit’ button (G17), the Mail receiver input area (G18), the Carbon copy (CC) receiver input area (G19), the Mail title input area (G20), and the Mail message input area (G21). The form of the mail writes & send interface is not limited to the example mentioned above.

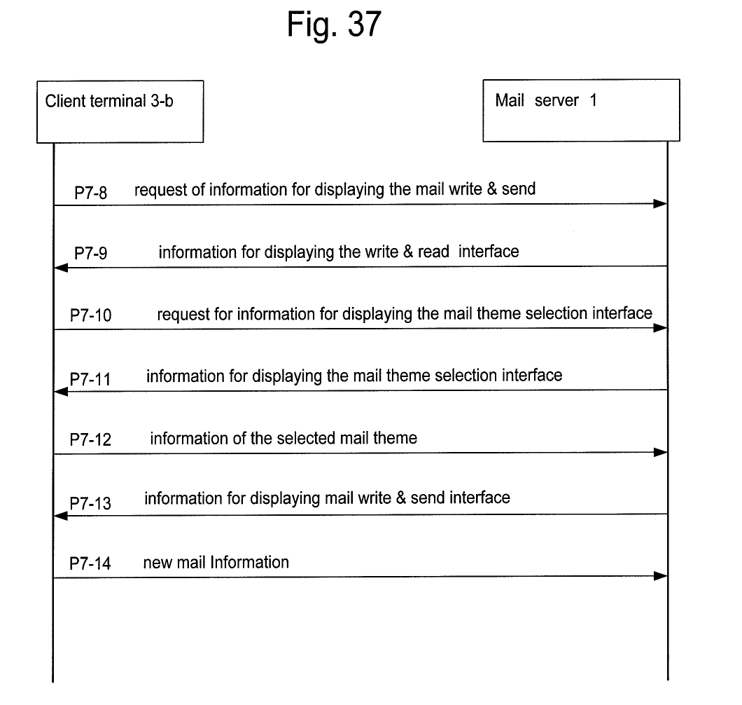

The mail creation process will be described in detail as follows. FIG. 37 is the sequence diagram of the mail creation process (steps P7-8 to P7-14). Initially, it is assumed that the mailbox overview shown in FIG. 18 on the screen in the display section 9 is included in the client terminal 3-b.

When the end-user ‘SIMIZU’ clicks the ‘New Mail’ button (G12) in the mailbox overview shown in FIG. 18, the processing section 8 in the client terminal 3-b transmits a request for information to display the mail write & send interface containing the end-user identifier of ‘SIMIZU’ to the mail server 1 through the transmitting/receiving section 5 (P7-8).

In the mail server 1, the mail write & send interface generate section 23 and the authenticate end-user section 14 receive the request from the client terminal 3-b through the transmitting/receiving section 6.

Subsequently, the mail write & send interface generate section 23 gets the end-user identifier and the end-user name from authenticate end-user section 14, and generates the information for displaying the mail write & send interface containing the end-user name ‘SIMIZU’ of the client terminal 3-b. Then, the mail write & send interface generate section 23 transmits the generated information for displaying the mail write & send interface to the client terminal 3-b through the transmitting/receiving section 6 (P7-9).

In the client terminal 3-b, the processing section 8 receives the generated information for displaying the mail write & send interface from the mail server 1 through the transmitting/receiving section 5. Then the processing section 8 controls to display the mail write & send interface shown in FIG. 35 on the screen in the display section.

When the end-user clicks the ‘Select Mail Theme’ button (G3) in the mail write & send interface shown in FIG. 35 for selecting mail theme of new mail by using the input section 10, the process of the steps P7-10 to P7-12, which is similar to the process corresponding to step P7-3 to P7-5 mentioned above, is performed.

In the client terminal, the mail write & send interface generate section 23 and the authenticate end-user section 14 receive the information of the selected theme transmitted from the client terminal 3-b in the step P7-12. Subsequently, the mail write & send interface generate section 23 gets the end-user identifier and end-user name from the authenticate end-user section 14, and generates information for displaying new mail write & send interface containing information about the end-user name, the end-user identifier of the client terminal 3-b, and the selected mail theme. Then, the mail write & send interface generate section 23 transmits the generated information for displaying new mail write & send interface to the client terminal 3-b through the transmitting/receiving section 6 (P7-13).

In the client terminal 3-b, the processing section 8 receives the information for displaying the new mail write & send interface from the mail server1 through the transmitting/receiving section 5. Then, the processing section 8 controls so as to display the new mail write & send interface on the screen in the display section 9.

The end-user ‘SIMIZU’ inputs the mail title in the Mail title input area (G20), and mail message in the Mail message input Area (G21). Then ‘SIMIZU’ clicks the Tan Edit' button (G17) in order to make the new mail editable after the mail reaches the mailbox. The example of the mail write & send interface, in which these items are input, is shown in FIG. 36.

Returning to FIG. 37, when the end-user ‘SIMIZU’ clicks the ‘Send’ button (G16) in the mail write & send interface in the FIG. 36 by using the input section 10, the processing section 8 transmits the new mail information to the mail server 1 through the transmitting/receiving section 5 (P7-14). In the mail server 1, the mail insert section 24 receives the new mail information from the client terminal 3-b. Subsequently, the mail insert section 24 inputs information into the columns ‘Mail sender’, ‘Editable flag’, ‘Send/update time’, ‘Mail title’, and ‘Mail message’ of the new mail information in the mail storage section 21.

<<Mail Reading Process>>

In the following, it is assumed that the end-user ‘YUKO’ reads the mails.

FIG. 32 mentioned above shows the mailbox of the end-user ‘YUKO’ containing the mail theme ‘Automobile>Sports Car’ before the end-user ‘SIMIZU’ clicks the ‘Send’ button (G16) in FIG. 36, mentioned above. FIG. 33, mentioned above, shows the ‘YUKO’ containing the mail theme ‘Automobile>Sports Car’ after ‘SIMIZU’ clicks the ‘Send’ button (G16) in FIG. 36. The mailbox is updated when it is opened or when the ‘Update’ button (G14) in FIG. 32 or FIG. 33 is clicked by the end-user in the mailbox. In the mailbox of ‘YUKO’ shown in FIG. 33, there is now a new mail, of which the title is ‘Flowing Elegant! Gran Turismo’ received from ‘SIMIZU’, which has been added. Note that the process for displaying a mailbox is mentioned above.

When the end-user ‘YUKO’ clicks the new mail, of which the title is ‘Flowing Elegant! Gran Turismo’, in FIG. 33 by using the input section 10, the processing section 8 transmits a request for mail information containing the mail identifier to the mail server 1 through the transmitting/receiving section 6 (similar to the step P7-19 in FIG. 31). In the mail server, the mail extract section 25 receives the request for the mail information form the client terminal 3-a through the transmitting/receiving section 6. Then, the mail extract section 25 selects and extracts the mail information from the mail storage section 21 by using the mail identifier. As mentioned above, the mail information contains information about the mail identifier, the mail sender, the mail receiver (the mailbox owner name), the mail theme, the editable flag, send time, the mail title, and the mail message.

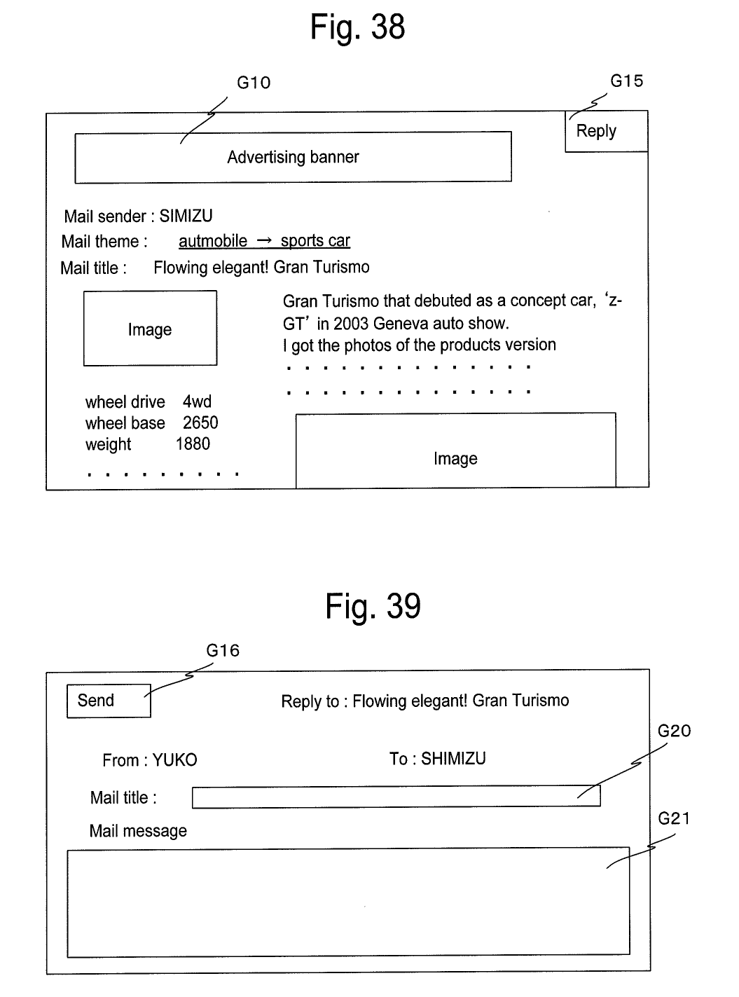

Then, the mail extract section 25 transmits the extracted mail information to the client terminal 3-a through the transmitting/receiving section 6 (similar to the step 7-20 in FIG. 31). In the client terminal 3-a, the processing section 8 receives the mail information from the mail server 1 through the transmitting/receiving section 5. The processing section 8 controls so as to display the mail on the screen in the display section 9. The example of the mail ‘Flowing Elegant! Gran Turismo’ is shown in FIG. 38.

<<Mail Replying Process>>

In the followings, it is assumed that the end-user ‘YUKO’ replies to the mails.

When the end-user ‘YUKO’ clicks on the ‘Reply’ button (G15) in FIG. 38, the processing section 8 transmits a request of information for displaying the mail write & send interface for the reply e-mail with the end-user profile to the mail server 1 through the transmitting/receiving section 5 (similar to P7-8 in FIG. 37). In the mail server 1, the mail write & send interface generate section 23 and the authenticate end-user section 14 receive the request from the client terminal 3-a through the transmitting/receiving section 6.

Subsequently, the mail write & send interface generate section 23 gets the end-user identifier and the end-user name from authenticate end-user section 14, and generates the information for displaying the mail write & send interface for the reply e-mail containing the end-user name ‘YUKO’ of the client terminal 3-a. Then, the mail write & send interface generate section 23 transmits the generated information for displaying the mail write & send interface for the reply to the client terminal 3-a through the transmitting/receiving section 6 (similar to the step P7-9 in FIG. 37).

In the client terminal 3-a, the processing section 8 receives the generated information for displaying the mail write & send interface for the reply from the mail server 1 through the transmitting/receiving section 5. Then the processing section 8 controls to display the mail write & send interface for displaying the reply e-mail on the screen in the display section. The mail write & send interface for the reply is shown in FIG. 39. As shown in FIG. 39, the mail write & send interface for the reply contains the mail sender ('YUKO'), the mail receiver ('SIMIZU') and the mail title input area (G20), the mail message input area (G21), and the ‘Send’ button (G16).

The end-user ‘YUKO’ inputs the mail title in the mail title input area (G20), and the mail message in the Mail message input area (G21), then clicks the ‘Send’ button (G16) by using the input section 10. When the end-user ‘YUKO’ clicks the ‘Send’ button (G16), the processing section 8 transmits the new mail information to the mail server 1 through the transmitting/receiving section 5 (similar to the step P7-14 in FIG. 37). As previously mentioned above, the mail server 1 receives and saves the new mail information.

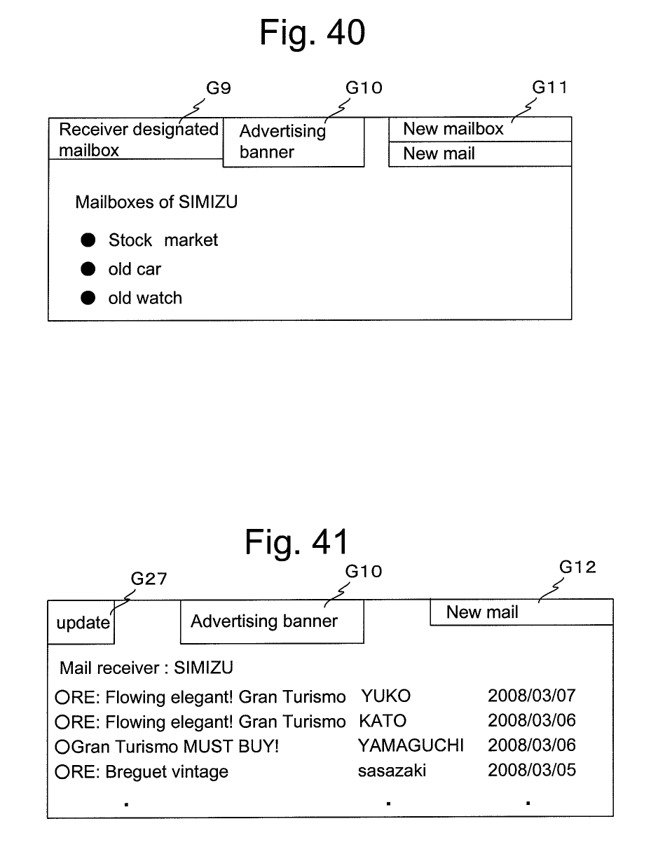

When the end-user ‘SIMIZU’ clicks the ‘Receiver designated mailbox’ button (G9) in the mailbox overview of the end-user ‘SIMIZU’ shown in FIG. 40 by using the input section 10 in the client terminal 3-b, the processing section 8 in the client terminal 3-b transmits a request for information for displaying the mailbox designated by the receiver with the end-user profile to the mail server 1 through the transmitting/receiving section 5 in the client terminal 3-b (similar to the step P7-17 in FIG. 31).

In the mail server, the mailbox generate section 22 and the authenticate end-user section 14 receive the request from the client terminal 3-b through the transmitting/receiving section 6. Subsequently, the mailbox generate section 22 gets the end-user identifier and the end-user name from the authenticate end-user section 14, and selects the mail information that has the end-user identifier in the column ‘mail receiver’ in the mail storage section 21.

Next, the mailbox generate section 22 extracts the mail information about the mail identifier, the mail sender, send/update time, the mail title, etc. and generates the receiver designated mailbox information that contains the mail identifiers, the mail senders, the send/update times, and the mail titles. Then, the mailbox generate section 22 transmits the extracted mail information to the client terminal 3-b through the transmitting/receiving section 6 (similar to the step P7-18 in FIG. 31).

In the client terminal 3-b, the processing section 8 receives the information for displaying the mailbox from the mail server through the transmitting/receiving section 6. Then, the processing section 8 controls to display the receiver designated mailbox of the end-user, ‘SIMIZU’ on the screen in the display section 9. The example of the mailbox in this case is shown in the FIG. 41.

When the end-user ‘SIMIZU’ clicks the mail title ‘RE: Flowing Elegant! Gran Turismo’ from ‘YUKO’ in the mailbox shown in FIG. 41 by using the input section 10, the processing section 8 transmits a request for the mail information containing the mail identifier with the end-user profile (similar to the step P7-19 in FIG. 31).

In the mail server 1, the mail extract section 25 receives the request from the client terminal 3-b through the transmitting/receiving section 6. Next, the mail extract section 25 extracts the mail identifier from the request for mail information. Subsequently, the mail extract section 25 selects the mail information in the mail storage section 21 by using the mail identifier. Then, the mail extract section 25 transmits the extracted mail information to the client terminal 3-b through the transmitting/receiving section 6 (similar to the step P7-20 in FIG. 31).

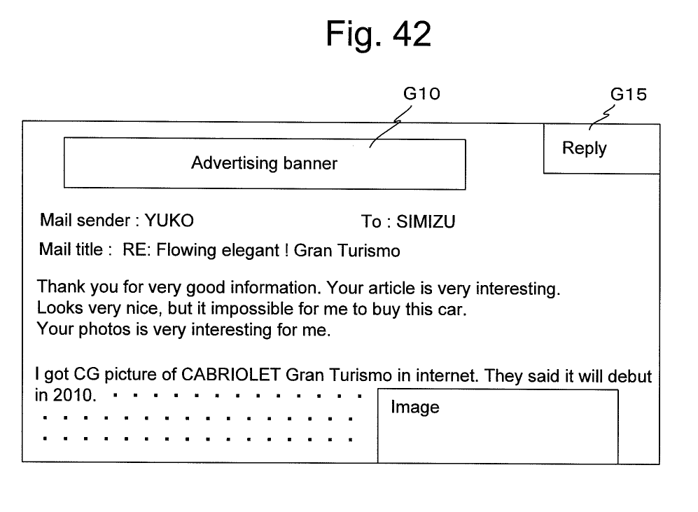

In the client terminal 3-b, the processing section 8 receives the mail information from the mail server 1 through the transmitting/receiving section 6. Then, the processing section 8 controls so as to display the mail ‘RE: Flowing Elegant! Gran Turismo’ from the end-user ‘YUKO’ on the screen in the display section 9. The example of the mail ‘RE: Flowing Elegant! Gran Turismo’ from the end-user ‘YUKO’ is shown in FIG. 42.

<<Mail Editing Process>>

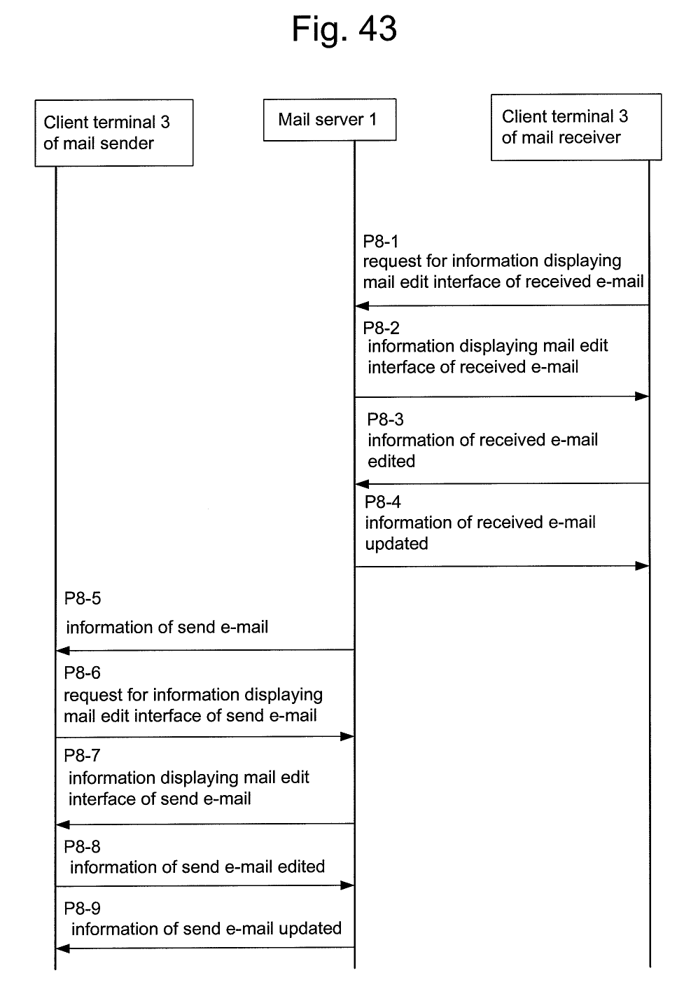

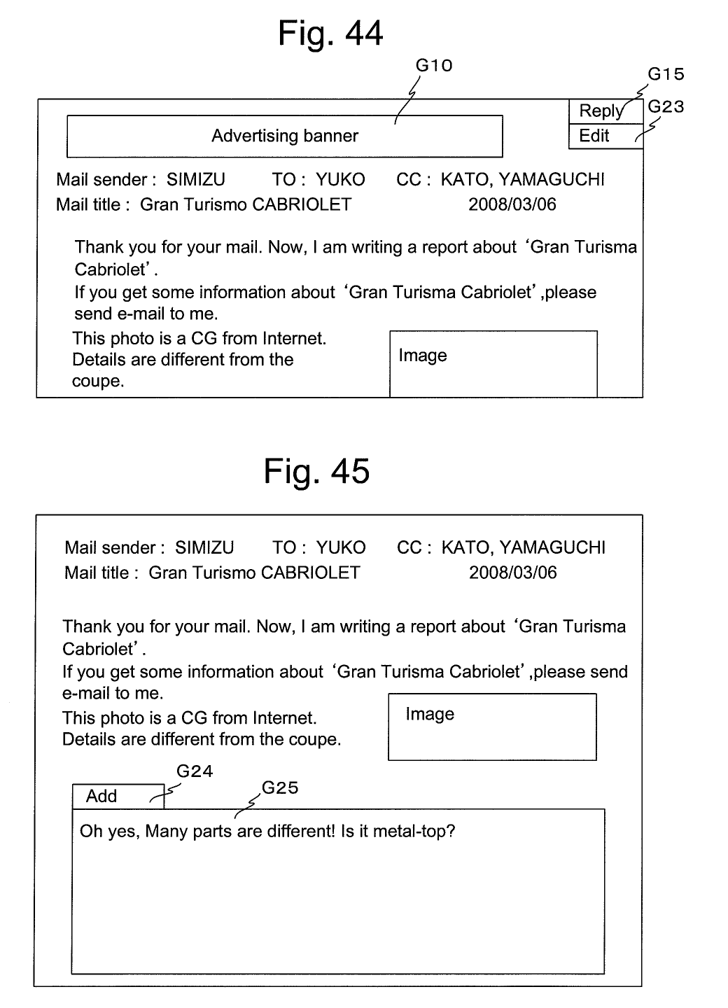

The process for editing mail will be described in detail as follows. FIG. 43 is the sequence diagram of the mail editing process. It is assumed that the mail shown in the FIG. 44 is displayed on the screen in the display section 9 included in the client terminal 3-a owned by the end-user ‘YUKO’.

FIG. 44 shows the mail to be edited by the end-user ‘YUKO’. This mail to be edited is the mail from ‘SIMIZU’ to ‘YUKO’, ‘KATO’, and ‘YAMAGUCHI’. This e-mail is made by using the mail write & send interface shown in FIG. 35. The process of creating this e-mail is almost the same process as the process mentioned above. The differences are as follows:

(a) The type of the mail writes & sends Interface used is the one shown in FIG. 35, not FIG. 39. The type illustrated in FIG. 39 is a specific reply when the mail sender's name and mail receiver's name are already shown;

(b) The mail sender ‘SIMIZU’ inputs mail receivers in the mail receiver input area (G19) and the carbon copy (CC) receiver input area in FIG. 35;

(c) The mail sender ‘SIMIZU’ clicks the ‘Can Edit’ button (G17) in FIG. 44.

Due to clicking the ‘Can Edit’ button (G17), the mail information of this mail in the mail storage section 21 will have ‘1’ in the column of ‘Editable flag’ (FIG. 11). In this example, ‘1’ means that the mail is editable by either of the mail sender or mail receiver (the mailbox owner) after the mail reaches to the mailbox. And ‘0’ means that the e-mail is not editable. Of course, the role of ‘1’ and ‘0’ is changeable, and any value is useable.

Returning to FIG. 44, when the end-user ‘YUKO’ clicks the ‘Edit’ button (G23) by using the input section 10, the processing section 8 transmits a request of information for displaying the mail edit interface which contains the mail identifier with the end-user profile to the mail server 1 through the transmitting/receiving section 5 (P8-1). In the mail server 1, the mail edit interface generate section 29 and the authenticate end-user section 14 receive the request from the client terminal 3-a through the transmitting/receiving section 6.

Subsequently, the mail edit interface generate section 29 gets the end-user identifier and end-user name from the authenticate end-user section 14 and extracts the mail identifier from the request. Then, the mail edit interface generate section 29 selects the mail information from the mail storage section 21 by using the extracted mail identifier.

Next, the mail edit interface generate section 29 generates information for displaying the mail edit interface containing the extracted end-user identifier, based on the selected mail information. Then, the mail edit interface generate section 29 transmits the generated information to the client terminal 3-a through the transmitting/receiving section 6 (P8-2).

In the client terminal 3-a, the processing section 8 receives the information for displaying the mail edit interface from the mail server 1 through the transmitting/receiving section 5. Then, the processing section 8 controls so as to display the mail edit interface on the screen in the display section 9. The example of the mail edit interface in this case is shown in FIG. 45 containing the comment input area (G25) and the ‘Add’ button (G24) under the mail message.

The end-user ‘YUKO’ inputs comment in the comment input area (G25) and clicks the ‘Add’ button (G24). Returning to FIG. 43, when the ‘Add’ button (G24) is clicked, the processing section transmits the edited mail information with the end-user profile to the mail server 1 through the transmitting/receiving section 5 (P8-3 in FIG. 43).

In the mail server 1, the mail update section 26 receives the edited mail information with end-user profile from the client server through the transmitting/receiving section 6. Then, the mail update section 26 updates the mail information in the mail storage section 21, based on the edited mail information. Then, the mail update section 26 transmits the updated mail information to the client terminal 3-a through the transmitting/receiving section 6 (P8-4).

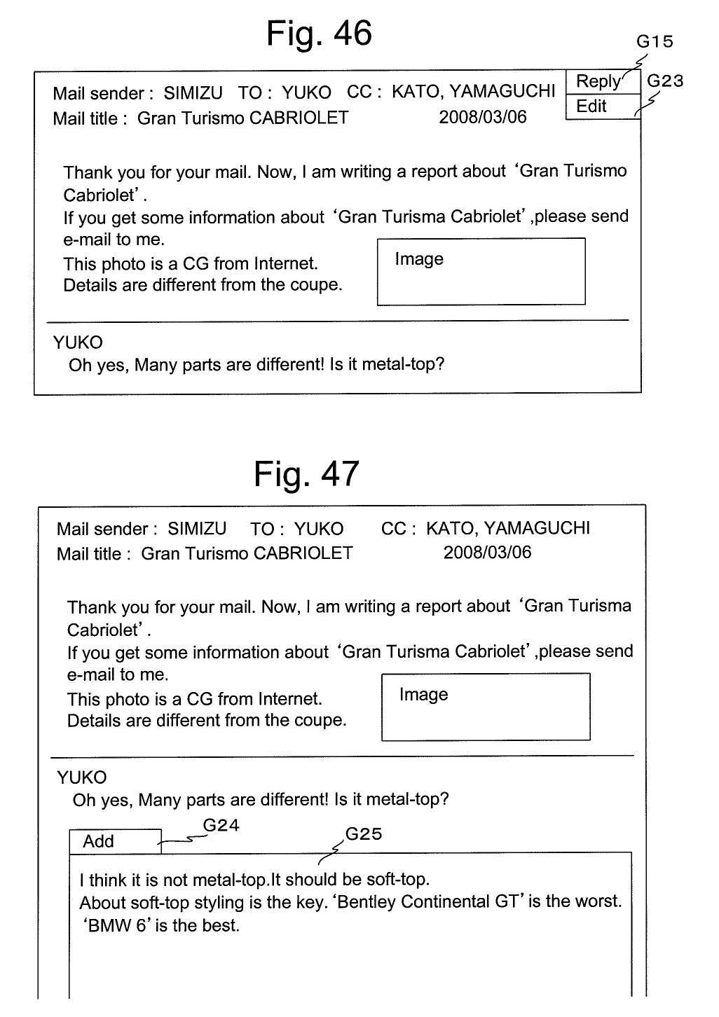

In the client terminal 3-a, the processing section receives the updated mail information from the mail server 1 through the transmitting/receiving section 5. Then, the processing section 8 controls so as to display the updated e-mail on the screen in the display section 9. The example of the updated e-mail is shown in FIG. 46.

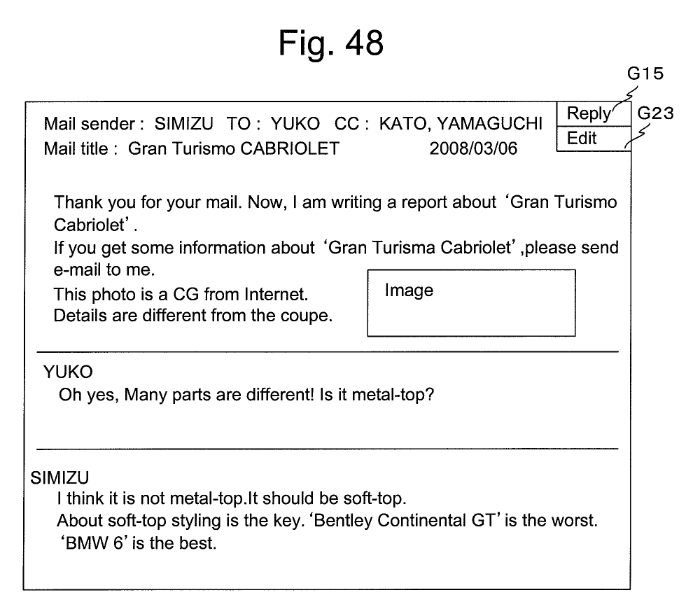

The mail sender ‘SIMIZU’ can edit the mail shown in FIG. 46 by using the mail edit interface shown in FIG. 47. This mail editing process is shown in FIG. 43 as the process including the steps P8-6 to P8-9, which is similar to the process including the steps P8-1 to P8-4. FIG. 48 shows the mail updated by the mail sender ‘SIMIZU’.

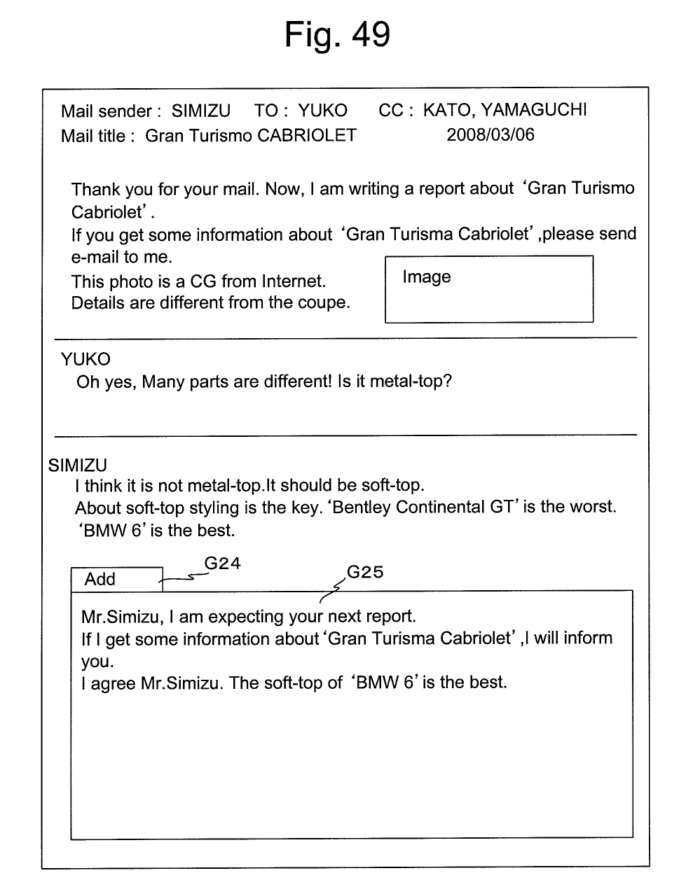

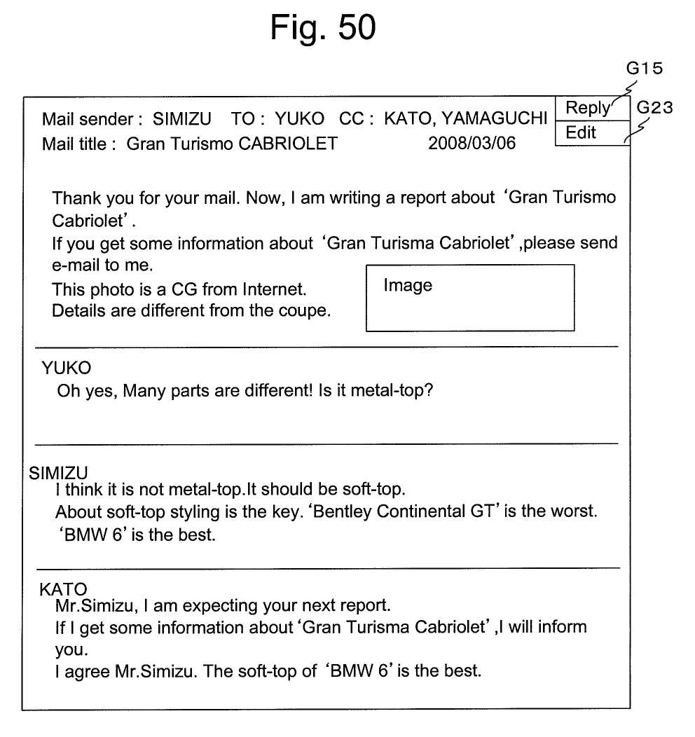

The mail receiver ‘KATO’ can further edit the mail shown in FIG. 48 by using the mail edit interface shown in FIG. 49. This mail editing process is similar to the process including the steps P8-1 to P8-4. FIG. 50 shows the mail updated by the mail receiver ‘KATO’.

As mentioned above, the mail receiver and the sender can edit mail addressed to them.

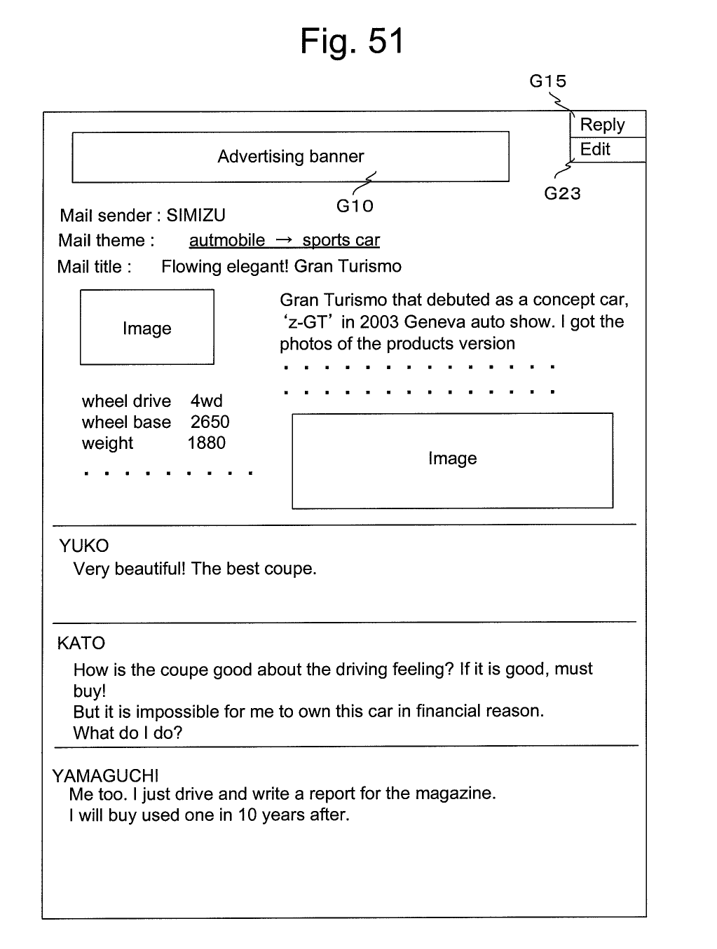

The e-mail to be edited can also be specified by using the mail theme. FIG. 51 shows the e-mail after the end-users ‘YUKO’, ‘KATO’, and ‘YAMAGUCHI’ edit the mail shown in FIG. 38 continuously.

Note that comments are added and the mail message is not edited in the e-mail editing mentioned above.

Next, the case where the mail message is actually edited will be described as follows.

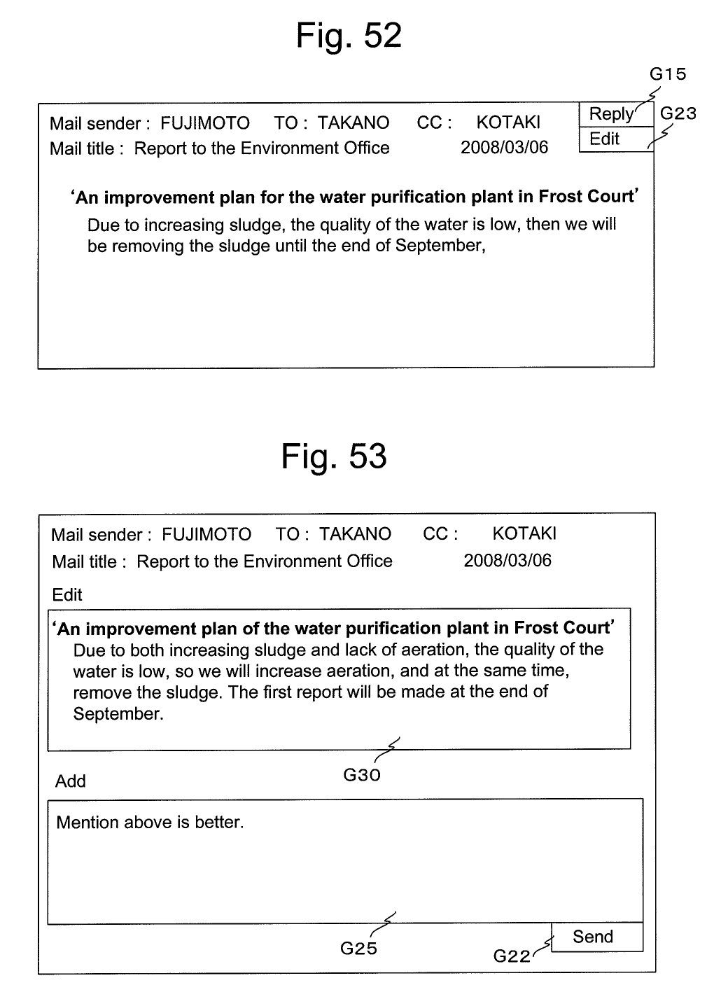

FIG. 52 shows the e-mail from ‘FUJIMOTO’ to ‘TAKANO’ and ‘KOTAKI’, which is displayed on the screen in the display section 9, included in the client terminal 3-d owned by the end-user ‘TAKANO’. The process of making and sending this e-mail is already mentioned above. The process for displaying this e-mail in the client terminal 3-d is also already mentioned above.

When the End-user ‘TAKANO’ clicks the ‘Edit’ button (G23) in FIG. 52 by using the input section 10 in the client terminal 3-d, the mail edit interface shown in FIG. 53 is displayed on the screen in display section 9, as mentioned above. The mail edit interface shown in FIG. 53 is different from the mail edit interfaces shown FIGS. 45, 47, and 49. The difference between them and that shown in FIG. 53 is that the mail edit interface shown in FIG. 53 further contains a mail message edit area (G30).

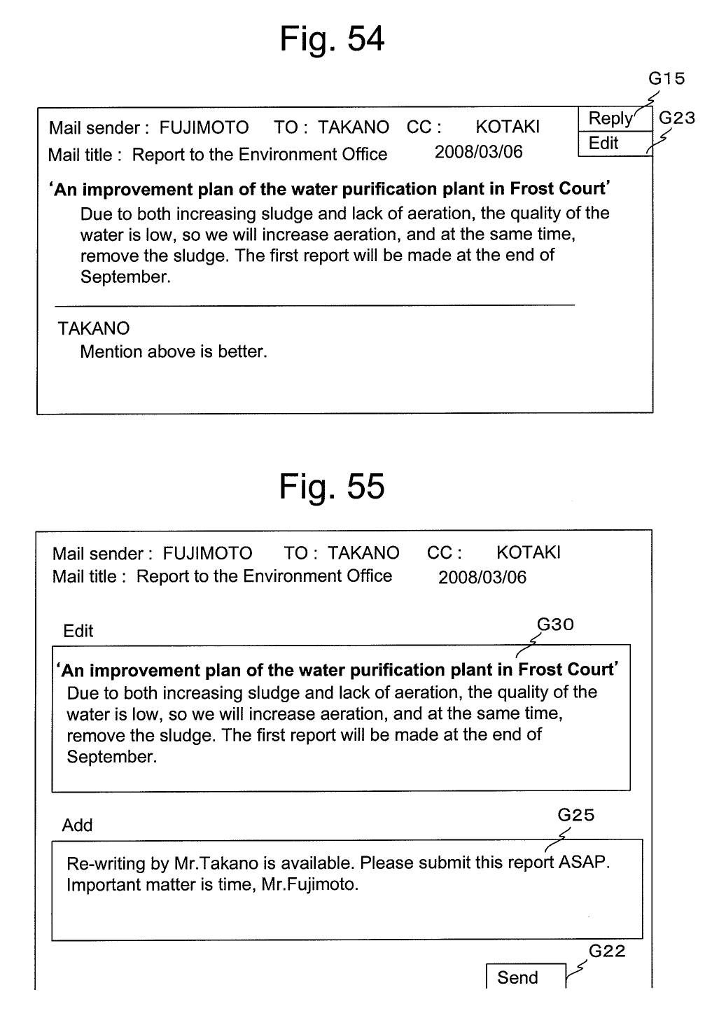

The end-user ‘TAKANO’ inputs the edited mail message into the Mail Message Edit Area (G30) and a comment into the comment input area (G25), and then clicks the ‘Send’ button (G22) by using the input section 10. When the ‘Send’ button (G22) is clicked, the updated e-mail shown in FIG. 54 is displayed on the screen in the display section 9. This process is mentioned above.

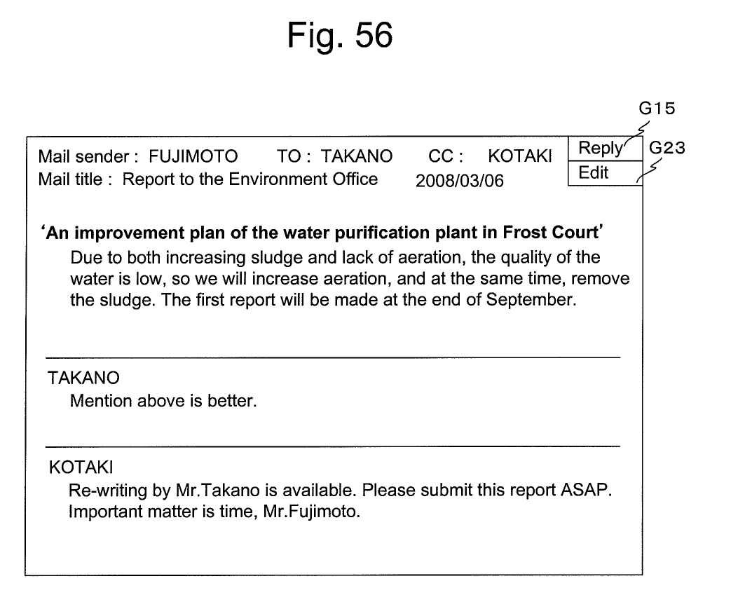

The mail receiver ‘KOTAKI’ is also able to open the e-mail shown in FIG. 54 on the screen in the display section 9 included in his client terminal 3-e. When the end-user ‘KOTAKI’ clicks the ‘Edit’ button (G23) in FIG. 54, the mail edit interface shown in FIG. 55 is displayed on the screen in the display section 9. The end-user ‘KOTAKI’ inputs a comment into the comment input area (G25) and does not edit the mail message in the mail message edit area (G30) in FIG. 55. Then, the end-user ‘KOTAKI’ clicks the ‘Send’ button (G22) in FIG. 55. Due to the click, the updated e-mail shown in FIG. 56 is displayed on the screen in the display section 9. FIG. 56 shows the e-mail after ‘KOTAKI’ has finished editing. An overview of the communication history about this mail is shown in FIG. 56. It is the history of the communication.

Note that the mail sender ‘FUJIMOTO’ and the mail receiver ‘TAKANO’, ‘KOTAKI’ can read the e-mail at any time.

As mentioned above, the mail to be edited is the e-mail where the receiver is designated. The e-mail sharing the specified mail theme can also be edited in terms of the mail message.

<<Advertising Banner Displaying Process>>

In the mail delivery system 100, the end-user sets up a mailbox with a specific mail theme. The end-user's interest in the mail theme is selected in the process of setting up the mailbox. Sending an advertising banner that has the same mail theme as the mailbox is a means of collecting useful information for the end-user who initially set up the mailbox(es). The end-user can utilize advertising banners as an information-collecting tool.

From the marketer's side, the advertisers can effectively provide advertising banners to customers who are interested in their products/services. Therefore, the advertisers can expect to optimize impact of their products/services in the market.

The process for displaying an advertising banner in Client Banner 3-x (x=a, b, . . . ) will be described in detail as follows.

As mentioned above, after login, the processing section 8 in the client terminal 3-x transmits various requests with the end-user profile to the mail server 1 through the transmitting/receiving section 6, when the client terminal 3-x accesses the mail server 1. In the mail server 1, the authenticate end-user section 14 receives the requests with the end-user profile from the client terminal 3-x through the transmitting/receiving section. Then, the authenticate end-user section 14 validates the end-user.

Of course, the mail server 1 distinguishes the end-user using the client terminal 3-x and gets the relevant end-user identifier. The marketer is an individual or an organization who promotes the product/service information using the advertising banner.

In FIGS. 18, 19, 32 to 34, 38, 40 to 42, 44, and 51, the ‘Banner’ button (G10) is shown. When the ‘Banner’ button (G10) is clicked by the end user of the client terminal 3-x, the processing section 8 transmits a request for displaying the web page whose URL is embedded the ‘Banner’ button (G10) through the transmitting/receiving section 5.

The processing section 8 in the client terminal 3-x transmits a request for displaying the web page such as mail, mailbox, mailbox overview or other web pages with the end-user profile to the mail server 1 through in the transmitting/receiving section 5.

In the mail server 1, the advertising banner generate section 28 and the authenticate end-user section 14 receive the request with the end-user profile from the client terminal 3-x through transmitting/receiving section 6. Then, the authenticate end-user section 14 gets the end-user identifier and the advertising banner generate section 28 selects the specified mail theme from the mailbox storage section 19 by searching the column ‘Mailbox Owner’ by using the end-user identifier. Then, the advertising banner generate section 28 gets the mail theme identifier(s) that have been initially specified in the mailbox(es) setup process.

Next, the advertising banner generate section 28 selects the advertising banner identifier, the linked URL, and the banner image file URL from the advertising banner storage section 27 by searching the mail theme column by using the mail theme identifier(s) selected from the mailbox storage section 19. Subsequently, the advertising banner generate section 28 generates the information for displaying the advertising banner, based on the advertising banner identifier, the linked URL, and the banner image file URL which are selected. Then, the advertising banner generate section 28 transmits the generated information for displaying the advertising banner to the client terminal 3-x through the transmitting/receiving section 6.

In the client terminal 3-x, the processing section 8 receives the information for displaying the advertising banner from the mail server through the transmitting/receiving section 5. Then, the processing section 8 controls so as to display the advertising banner in web page format on the screen in the display section 9.

In the case that the advertising banner information shown in FIG. 14, the banner contains the text message instead of the images. If the marketer wants to use both of the image and the text, the advertising banner information needs to contain both columns of ‘Banner image file URL’ and of ‘Banner text’.

### Second Embodiment

Next, the second embodiment according to this invention will be explained. In the second embodiment, the format of the mailbox information shown in FIG. 9 is employed. The process of mailbox displaying in the second embodiment will be described as follows.

The differences between the first embodiment and the second embodiment are as follow:

(a) The process performed by the mail server 1 after the mail server received the new mail information issued in the step P7-14;

(b) The process performed by the mail server 1 from the reception of the request of the information for displaying the mailbox issued in the step P7-17 to the transmission of the information for displaying the mailbox in the step P7-18.

In the second embodiment, other processes are similar to the first embodiment.

<<Difference 1>>

When the end-user ‘SIMIZU’ clicks the ‘Send’ button (G16) in the mail write & send interface shown in the FIG. 36 by using the input section 10, the processing section 8 transmits the new mail information to the mail server 1 through the transmitting/receiving section 5 (P7-14 in FIG. 37). In the mail server 1, the mail insert section 24 receives the new mail information from the client terminal 3-b. Next the mailbox insert section 24 extracts the information from the column ‘Mail identifier’, ‘Mail sender’, ‘Send/update time’, or ‘Mail title’ of the mail information in the mail storage section 21. Subsequently, the mailbox insert section 24 connects each item of information with ‘|’ to make a consolidated information like ‘286|SIMIZU| Gran Turismo CABRIOLET |2008/03/06’. Then, the mailbox insert section 24 adds the consolidated information to the information in the column ‘Received Mail’ of the mailbox storage section 21.

<<Difference 2>>

When the end-user ‘YUKO’ clicks the mailbox name ‘My Next Car’ in FIG. 19 by using the input section 10, the processing section 8 transmits a request for information to display the mailbox ‘My Next Car’ to the client terminal 1 through the transmitting/receiving section 5 (P7-17 in FIG. 31). The request for information to display the mailbox ‘My Next Car’ contains the mailbox identifier.

In the mail server 1, the mailbox generate section 22 and the authenticate end-user section 14 receive the request from the client terminal 3-a through the transmitting/receiving section 6. Subsequently, the mailbox generate section 22 gets the end-user identifier and the end-user name from the authenticate end-user section 14, and extracts the mailbox identifier from the received request. Then, the mailbox generate section 22 selects the mailbox information in the mailbox storage section 19 by using the mailbox identifier and extracts the information about the mailbox owner, the received mail, and the mailbox name.

Next, the mailbox generate section 22 generates the mailbox information, based on the extracted information. Then, the mailbox generate section 22 transmits the information of displaying the mailbox ‘My Next Car’ to the client terminal 3-a through the transmitting/receiving section 6 (P7-18 in FIG. 31).

It should be understood that the embodiments described and illustrated herein are only examples and should not be considered as limiting the scope of the present invention. Other variations and modifications may be made in accordance with the spirit and scope of the present invention.

What is claimed is:

1. An e-mail delivery method used in an e-mail delivery system in which a plurality of client terminals is connected to an e-mail delivery server via network, comprising the steps of
transmitting a first request for first information from a client terminal in the plurality of client terminals to the e-mail delivery server, the first information being an overview information of e-mails related to a mail-box provided for the client terminal in the e-mail delivery sewer, the e-mails being transmitted from the plurality of client terminals with a mail sender name and a mail title;
transmitting the first information from the e-mail delivery sewer to the client terminal;
displaying the overview of the e-mails on a screen of the client terminal, based on the first information received from the e-mail delivery sewer;
transmitting a second request for second information from the client terminal to the e-mail delivery server; the second information being e-mail information of an e-mail chosen among the overview of the e-mails displayed;
transmitting the second information from the e-mail delivery server to the client terminal; and
displaying the e-mail on the screen of the client terminal, based on the second information received from the e-mail delivery sewer.

2. The e-mail delivery method according to claim 1; wherein
the client terminal is held by a sender of the e-mail and/or an owner of the mailbox, and
the e-mail delivery method further comprises;
transmitting third information from the client terminal to the e-mail delivery sewer, the third information being that as edited result by using the e-mail, referring the e-mail displayed; and
updating information of the e-mail in the mailbox based on the third information received from the client terminal.

3. The e-mail delivery method according to claim 1 further comprising:
transmitting fourth information for generating a theme-designating mailbox from the client terminal to the e-mail delivery server, the theme-designating mailbox having a name, an owner's name, and a mail theme;
generating the theme-designating mailbox in the e-mail delivery server, mails with the mail theme being related to the theme-designating mailbox.

4. The e-mail delivery method according to claim 3 further comprising:
transmitting a third request for fifth information from the client terminal to the e-mail delivery server, the fifth information being used for selecting the mail theme;
transmitting the fifth information from the e-mail delivery server to the client terminal; and
displaying mail theme selecting information on the screen of the client terminal, based on the fifth information received from the e-mail delivery server.

5. The e-mail delivery method according to claim 3 further comprising:
transmitting a fourth request for sixth information from the client terminal to the e-mail delivery server, the sixth information being overview information of mailboxes owned by holder of the client terminal;
transmitting the sixth information from the e-mail delivery server to the client terminal; and
displaying the overview of the mailboxes on the screen of the client terminal, based on the sixth information received from the e-mail delivery server.

6. The e-mail delivery method according to claim 3 further comprising:
transmitting a fifth request for seventh information from the client terminal to the e-mail delivery sewer, the seventh information being banner information corresponding to the mail theme of the theme-designating mailbox;
transmitting the seventh information from the e-mail delivery server to the client terminal; and
displaying the banner on the screen of the client terminal, based on the seventh information received from the e-mail delivery server

7. The e-mail delivery method according to claim 3, further comprising:
transmitting eighth information for registering a mail theme designated at the client terminal from the client terminal to the e-mail delivery sewer, the eighth information including the designated mail theme and at least one of parent themes, the at least one of parent themes being belonged to a higher layer than a layer in which the designated mail theme is belonged, and
registering the designated mail theme into the e-mail delivery system.

8. The e-mail delivery method according to claim 7, wherein
the eighth information further includes at least one of a child themes, the at least one of child themes being belonged to a lower layer than a layer in which the designated mail theme is belonged.

9. An e-mail delivery system in which a plurality of client terminals is connected to an e-mail delivery sewer via network, wherein
a client terminal in the plurality of client terminals comprises:
a display section configured to display a various image;
a first request section part configured to transmit a first request for first information in the plurality of client terminals to the e-mail delivery sewer, the first information being an overview information of e-mails related to a mail-box in the e-mail delivery sewer, the e-mails being transmitted from the plurality of client terminals with a mail sender name and a mail title;
a first display control section configured to control the display section for displaying the overview of the e-mails on a screen of the display section, based on the first information received from the e-mail delivery sewer;
a second request section configured to transmit a second request for second information to the e-mail delivery sewer; the second information being an e-mail information of an e-mail chosen among of the overview of the e-mails displayed; and
a second display control section configured to control the display section for displaying the e-mail on the screen, based on the second information received from the e-mail delivery server; and
the e-mail delivery server comprises:
a mail storage section configured to hold the e-mails;
a mailbox storage section configured to hold mailbox information;
a first response returning section configured to transmitting the first information to the client terminal; and
a second response returning section configured to transmitting the second information to the client terminal.

10. The e-mail delivery system according to claim 9; wherein
the client terminal is held by a sender of the e-mail and/or an owner of the mailbox,
the client terminal further comprises an edited result transmitting section configured to transmit third information to the e-mail delivery server, the third information being that as edited result by using the e-mail, referring the e-mail displayed; and
the e-mail delivery server further comprises an update section configured to update information of the e-mail in the mailbox based on the third information received from the client terminal.

11. The e-mail delivery system according to claim 9, where in
the client terminal comprises a mailbox information transmitting section configured to transmit a fourth information for generating a theme-designating mailbox to the e-mail delivery server, the theme-designating mailbox having a name, an owner's name, and a mail theme;
the e-mail delivery server further comprises a mailbox generating section configured to generate the theme-designating mailbox in the e-mail delivery server, mails with the mail theme being related to the theme-designating mailbox.

12. The e-mail delivery system according to claim 11, wherein
the client terminal further comprises:
a third request section configured to transmit third request for a fifth information to the e-mail delivery server, the fifth information being used for selecting the mail theme; and
a third display control section configured to control the display section for displaying a mail theme selecting user-interface image on the screen, based on the fifth information received from the e-mail delivery sewer, and
the e-mail delivery server further comprises a third response returning section configured to transmit the fifth information to the client terminal.

13. The e-mail delivery system according to claim 11, wherein
the client terminal further comprises:
a fourth request section configured to transmit a fourth request for sixth information to the e-mail delivery sewer, the sixth information being an overview information of mailboxes owned by holder of the client terminal; and
a fourth display control section configured to control the display section for displaying the overview of the mailboxes at the client terminal, based on the sixth information received from the e-mail delivery server on the screen, and
the e-mail delivery server further comprises a fourth response returning section configured to transmit the sixth information to the client terminal.

14. The e-mail delivery system according to claim 11, wherein
the client terminal further comprises:
a fifth request section configured to transmit a fifth request for seventh information to the e-mail delivery server, the seventh information being a banner information corresponding to the mail theme of the theme-designating mailbox; and
a fifth display control section configured to control the display section for displaying the banner on the screen, based on the seventh information received from the e-mail delivery server, and
the e-mail delivery server further comprises a fifth response returning section configured to transmit the seventh information to the client terminal.

15. An e-mail delivery server connected to a plurality of client terminals via network, comprising:
a mail storage section configured to hold the e-mails;
a mailbox storage section configured to hold mailbox information;
a first response returning section configured to transmitting first information to the client terminal terminals in response to a first request received from the client terminal, the first information being an overview information of e-mails related to the mailbox, the e-mails being transmitted from the plurality of client terminals with a mail sender name and a mail title; and
a second response returning section configured to transmitting second information to the client terminal in response to a second request received from the client terminal, the second information being e-mail information of an e-mail selected from the e-mails based on displayed result of the overview of the e-mails.

16. The e-mail delivery server according to claim 15, further comprising:
an update section configured to update information of the e-mail in the mailbox based on third information received from the client terminal, the third information being edited result of the e-mail performed by using a displayed result of the e-mail, wherein the client terminal is held by a sender of the e-mail and/or an owner of the mailbox.

17. The e-mail delivery server according to claim 15, further comprising:
a mailbox generating section configured to generate a theme-designating mailbox, when fourth information for generating the theme-designating mailbox is received from the client terminal, the theme-designating mailbox having a name, an owner's name, and a mail theme, mails with the mail theme being related to the theme-designating mailbox.

18. The e-mail delivery server according to claim 17, further comprising:
a third response returning section configured to transmit fifth information to the client terminal in response to a third request received from the client terminal, the fifth information being used for selecting the mail theme in the client terminal.

19. The e-mail delivery server according to claim 17, further comprising:
a fourth response returning section configured to transmit sixth information to the client terminal in response to a fourth request received from the client terminal, the sixth information being an overview information of mailboxes owned by user of the client terminal.

20. The e-mail delivery server according to claim 17, further comprising:
a fifth response returning section configured to transmit seventh information to the client terminal in response to a fifth request received from the client terminal, the seventh information being a banner information corresponding to the mail theme of the theme-designating mailbox.
